(19) United States
(12) Patent Application Publication
(10) Pub. No.: US 2008/0104103 A1
(43) Pub. Date: May 1, 2008

(54) System and method for managing information using entity-centric objects

(76) Inventor: Thom Adams, Dallas, TX (US)

Correspondence Address: FULBRIGHT & JAWORSKI L.L.P, 2200 ROSS AVENUE, SUITE 2800, DALLAS, TX, 75201-2784, US

(21) Appl. No.: 11/591,359

(22) Filed: Nov. 1, 2006

(51) Int. Cl. G06F 7/00

(52) U.S. Cl. 707/102

(57) ABSTRACT

System and methods manage information using entity-centric objects. Systems and methods aid a user in staying abreast of up-to-date information about particular named-entities that are of interest to the user. Entity-centric objects are employed for organizing information about corresponding entities. In general, the entity-centric objects are software objects (e.g., data structures) that contain information (which may be information collected electronically, such as via the web, and/or which may be provided by any of various information sources) about a corresponding entity, such as a corresponding named-entity. The entity-centric objects contain predefined categories of information about a corresponding named-entity, such as photograph(s), statistics, news, biographical information, upcoming dates of interest, etc. A user may select those named-entities that are of interest to the user, and the corresponding entity-centric objects for the selected named-entities are associated with the user and facilitate satisfying the user's informational desires about the named-entities.

### CROSS-REFERENCE TO RELATED APPLICATIONS

Not applicable.

### TECHNICAL FIELD

The following description relates generally to information management, and more specifically to utilizing entity-centric objects for managing information about entities that are of interest to users.

### BACKGROUND OF THE INVENTION

Today, more than ever, a vast array of information is available about entities that are of interest to users. Such information is available from a number of different sources, including electronic sources. For instance, much information can be found about an entity of interest electronically via, for example, the Internet (e.g., using search engines, such as GOOGLE™, YAHOO™, etc.). And, such information is commonly dispersed across multiple information sources, and search engines may point to those various sources.

A wide range of informational sources are available for use in finding information about an entity of interest. Today, a user desiring information about an entity of interest may use any number of such informational sources and information gathering techniques to find information about the entity of interest. For instance, if a user has informational desires about an entity, the user may first go to an informational source that has such a broad range of information that such source is likely to have information about the entity of interest. For instance, the user may lookup information about the entity in an encyclopedia, at a library, and/or may use a search engine, such as GOOGLE™, YAHOO™, etc., to search the world wide web (the “web”) for information about the entity.

Further, an informational source, such as a website, may be devoted to a particular type of information that is likely to contain information about an entity of interest. For instance, certain investment websites (such as Money.com, E-trade, TDAmeritrade, etc.) are available that are devoted to information about publicly-traded companies. Similarly, certain entertainment websites (such as Entertainment Weekly) are available that are devoted to information about celebrities, such as actors and actresses, etc. As another example, certain websites are devoted to world news (e.g., CNN), and other websites are devoted to sporting news (e.g., ESPN). As still another example, certain websites may be devoted to a given sport, such as the MLB.com website that is devoted to information about major league baseball. Some of such informational sources may charge a fee to access some or all of its information.

Further, a user may access an informational source that is specifically devoted to an entity of interest. For instance, many companies maintain websites that have information about themselves. Similarly, many celebrities have websites that are devoted to information about such celebrity.

Additionally, various blogs devoted to particular topics are available, which a user may join in order to receive information. Also, users may subscribe to RSS feeds and/or email or other types of newsletters to have information about particular topics or entities sent to the users as such information becomes available to the source.

In view of the above, various techniques for obtaining information about entities of interest are available to users. Never has more information been available about entities of interest from more informational sources. However, with the proliferation of available information about entities, difficulty has arisen in searching for information, filtering through the wide array of available information for non-duplicative information that is of interest, organizing such information, and updating the information to maintain up-to-date knowledge about an entity of ongoing interest. While the exemplary techniques mentioned above may be used by a user to gain information about an entity, the techniques undesirably burden the user with responsibility for searching for information about an entity of interest and filtering the information for non-duplicative information that is of interest, as well as periodically repeating the process to update the user's knowledge as the information changes and/or new information becomes available. Thus, difficulty may arise for a user in keeping abreast of an entity given all the informational sources, and to keep abreast of new informational sources that become available.

In this regard, it becomes undesirably burdensome on a user to keep abreast of information about an entity, and the burden compounds as the number of entities that are of interest to a user increases. Traditional techniques for obtaining information about an entity are undesirably inefficient and burdensome to a user. Further, many of the traditional information sources are accessible by the user via a static site (e.g., a website), thus requiring the user to visit the static site to obtain the information. Accordingly, the information is not nomadic and does not follow the user as the user browses electronic information, and thus the information is not available to relate the user to the information when an appropriate context is encountered at another site. For instance, if a user obtains information about a given entity, using the traditional techniques described above, and then the user is reading a news article on the web about the entity, the previously obtained information is not related to the article for the user.

Thus, a desire exists for systems and methods that aid users in keeping abreast of emerging information pertaining to select entities of interest to the users, while easing the burden associated with staying abreast of such information, such as evaluating new sources of information for useability, gathering the information, etc.

### BRIEF SUMMARY OF THE INVENTION

The inventors of the present application have recognized that much of the information that persons desire to maintain (e.g., to stay abreast of) is information about certain types of entities. As used herein, an “entity” generally refers to an identifiable person, collection of people, company, institution, organization, or event, as examples. As used herein, a named-entity is defined as any one of the following three types of entities: (1) an unambiguously identifiable individual; that is, an identifiable human being or an individually identifiable (named or numbered) animal (i.e., an “individual entity”); (2) any identifiable, organized collection, or official role, comprised of or fulfilled by one or more named-entities (i.e., an “organization or collection of entities”); and (3) any identifiable, organized (e.g., schedulable and/or repeatable) event or set of events expressly produced for the gathering, performance, competition, duties, or interaction of named-entities (e.g., an “entity-based event”).

Examples of the first type of entity that is considered a named-entity, an individual entity, include: A) “Condoleeza Rice”, “Angelina Jolie,” and “Tiger Woods” are examples of individual entities; B) “Shi Shi,” an individual Panda housed at the San Diego Zoo, and “Shamu” an identifiable whale at Sea World are also examples of individual entities; and C) a rodeo bull identifiable by Branding Mark BR1234 is a further example of an individual entity, as defined herein. The following are not considered as individual, named-entities as defined above: “a dog”, “Border Collies”, “people with brown hair”, etc. These would not be individual entities under the above definition because they do not unambiguously and uniquely name a single human being or animal organism from all others in the universe, but rather are directed to broad classes into which many individuals may fit. It should be recognized that there may be some overlap or ambiguity as between individual entities. For example, the named entity “Kenny Rogers” may refer to a country music singer having that name or to a baseball player in Major League Baseball having the same name. Thus, while a portion of the identifier (e.g., name) of an individual entity may overlap with other individual entities, a given individual entity of interest is a single being that may be identified (e.g., in the context of other information, etc.).

The second type of entity that is considered a named-entity may be referred to as an “organization or collection of entities”. Such organization of entities may refer to any identifiable, organized collection, or official role, comprised of or fulfilled by one or more named-entities such that: (a) entities are expressly organized/placed, by themselves or by others, as members/officials of a unambiguously identifiable collection/role; and/or (b) the unambiguous identifiability of the collection/role itself is not dependent upon the set of entities that happen to comprise/fulfill the collection/role at any point in time; that is, the collection's/role's identifiability survives partial or complete re-composition. Examples of such organization of entities include: sports teams, associations, corporate entities, bands, governmental bodies, churches, etc.

Part (a) of the above definition of organization of entities ensures that collections of individuals are expressly organized and named, instead of merely being a collection of individuals that happen to share a characteristic. “The Supreme Court” (governmental body), “The Dallas Cowboys” (sports team), “Coca-Cola, Inc” (corporate entity), “Budweiser Clydesdales” (a named group of exhibition horses), “The Pope” (an official role), “U2” (musical band), and “Survivor” (television show) are examples of expressly organized collections of entities. Examples of collections of individuals that are NOT named-entities as defined above include “anyone who lives in Montana” (they are not expressly organized, they just happen to live there), “people with brown hair” (simply sharing a characteristic does not make the definition operational), “the ex-wives of George Hamilton” (the group is not expressly organized).

Part (b) of the above definition of organization of entities ensures that the entity being defined has some existence outside of and beyond the specific, individual members which may happen to comprise it at any one time. For example, sports teams continue to exist even if every single member of the team and the entire coaching staff are replaced with new individuals; the same applies to corporations in regard to their employees and boards; governmental bodies and their appointed or elected staff, etc. The definition does not require that an entity must continue to exist after re-composition; it merely states that it could.

The third type of entity that is considered a named-entity may be referred to as an “entity-based event”. Examples of such entity-based events include: The PGA Tour, Wimbledon, the Superbowl, the Olympics, The Supreme Court session, The Democratic Primary, and Survivor (television show). Examples of things which would not be considered entity-based events under the above definition are: “an eclipse”, “Hurricane Katrina”, “a trip to Oslo”, and “the birth of Sam Phillip's first daughter”.

As examples, the Professional Golf Association (PGA), as well as each discrete member of the PGA, such as Tiger Woods, are named-entities as that term is used herein. Similarly, discrete, identifiable events, such as certain PGA golf tournaments, as the U.S. Open, the Masters, etc., are named-entities as that term is used herein. However, the game of golf itself is not a named-entity as defined herein. As another example, the United States Supreme Court, as well as each discrete justice on the Supreme Court, are named-entities as that term is used herein, while “law” itself is not.

Consumers of information typically maintain psychological continuity among their own subjective informational needs and desires pertaining to such named-entities that are of interest to them. Consumers of information are often not merely seekers of specific fact situations (e.g., “who won the Superbowl?”); rather, they have desires regarding, or affinity to, some named entity whose ongoing existence is continually generating new possibilities for information (e.g., “I have some interest in the Superbowl, therefore I want to know who won it last year, and may also want to know when and where it is to be played this year, etc.”).

In this regard, named-entities may be viewed as information generators (as their actions result in information being generated). For instance, the mere act of some celebrity gaining weight or dating another individual, etc., may result in information being generated reporting such information about the celebrity to consumers of information who are interested in the celebrity. Consumers of information generally do not maintain ongoing interests in simply any stream of information, nor do they maintain interests in a set of facts once those facts are known, gathered, or stored; but rather, consumers of information often express interest in information, and they seek, gather, and store facts by virtue of having a focused, entity-centric interest in a named-entity which generates information (or about which information is generated by others).

Thus, named-entities, as defined herein, may be thought of as focused information generators. Many consumers of information have stable, ongoing interests in the named-entities themselves, and not in information or in mere sets of facts per se. Thus, as described further herein, certain embodiments of the present invention enable consumers to easily acquire, manage, and share information that is of interest by virtue of having been generated by a named-entity of interest. According to certain embodiments of the present invention, entity-centric objects are employed for respective named-entities, and users can collect the entity-centric objects that are of interest to the users. The collectibility of the entity-centric objects represents and facilitates the continuity of users' informational needs and desires.

The present invention is directed to a system and method which manage information using entity-centric objects. That is, embodiments of the present invention provide systems and methods that aid a user in staying abreast of up-to-date information about particular named-entities that are of interest to the user. Embodiments of the present invention employ entity-centric objects for organizing information about corresponding entities (e.g., named-entities). In general, the entity-centric objects are software objects (e.g., data structures) that contain information (which may be information collected electronically, such as via the web, and/or which may be provided by any of various information sources) about a corresponding entity, such as a corresponding named-entity. According to certain embodiments, the entity-centric objects contain pre-defined categories of information about a corresponding named-entity, such as photograph(s), statistics, news, biographical information, upcoming dates of interest, etc. An entity-centric object may be obtained from one or more sources by a user who finds the corresponding named-entity of interest. For instance, a user may select those named-entities that are of interest to the user, and the corresponding entity-centric objects for the selected named-entities are associated with the user and facilitate satisfying the user's informational desires about the named-entities, as described further herein.

Different types of entities may be categorized (e.g., by a publisher, as discussed below) into different categories. For instance, named-entities may be categorized into such categories as sporting figures, entertainment figures, political figures, companies, etc. The named-entities may be further sub-categorized. For instance, sporting figures may be sub-categorized by sport. For each category and/or sub-category of entities, informational categories may be defined, wherein each informational category indicates a type of information maintained for the named-entities in such category/sub-category. For example, as mentioned above, such informational categories as photograph(s), statistics, news, biographical information, upcoming dates of interest, etc., may be defined (e.g., by a publisher), wherein the corresponding types of information about a named-entity is organized into the respective informational category of the entity-centric object. In certain embodiments, different informational categories may be predefined for different types of named-entities. For instance, certain informational categories may be defined for sports figures, while other informational categories may be defined for political figures. Of course, some or all of the informational categories defined may be the same between different types of named-entities.

Further, in certain embodiments, a user may select, from a plurality of different categories of information that are maintained for a named-entity, those categories that are to be contained in the user's entity-centric object for the entity. For instance, a plurality of different informational categories, such as photographs, statistics, news, biographical information, and upcoming dates of interest may be maintained for sports figures (e.g., as defined by the publisher), and a user may, in certain embodiments, select any of those informational categories to be included in the user's entity-centric object of a sports figure. For instance, a user may obtain an entity-centric object for a given sports figure, and the user may specify that the user is interested only in statistics, news, and upcoming dates of interest for the named-entity, wherein the user's entity-centric object is configured to maintain only these selected categories of information.

According to certain embodiments of the present invention, entity-centric objects may be “published” by a publisher, and made available to users by one or more “sources.” Further, a “maintainer” dynamically updates information for the published entity-centric objects. One or more of the publisher, source, and maintainer may be the same, in some instances. Thus, while the publisher, source, and maintainer are separately designated herein based on their respective functions, in certain embodiments a common entity acts as two or more (e.g., all) of the publisher, source, and maintainer. Further, as described further herein, in certain embodiments some or all of the activities of the publisher and/or maintainer may be automated (e.g., performed autonomously by computer logic, such as hardware, software, firmware, or a combination thereof).

In general, a publisher may select an entity (e.g., a named-entity) for which an entity-centric object is to be published. For instance, the publisher may specify certain sports figures, celebrities, etc. for which entity-centric objects are to be published. The publisher may further categorize/sub-categorize the specified entities to, for example, designate each entity as a sporting figure, politician, entertainment celebrity, company, etc. The publisher may further define the informational categories that are to be maintained for each entity, such as photographs, news, statistics, etc. A source may make the published entity-centric objects available to users. For instance, a source may be a website that enables a user to select those entities that are of interest to the user and thus obtain the corresponding entity-centric objects. The maintainer employs techniques to dynamically update information contained in the published entity-centric objects, as described further herein.

In certain embodiments, the entity-centric objects further define a structured/organized manner in which to present the information contained therein to a user. For example, the information may be presented to a user such that the information is organized by each defined informational category (e.g., photographs, news, biographical information, statistics, etc.). As described further herein, in certain embodiments, the entity-centric objects define a presentation of the information in the form of an electronic trading card. In certain embodiments, the publisher may define a default structure/arrangement in which the information is to be presented. Further, in certain embodiments, a user may define a desired arrangement of the information to be presented for the user's entity-centric object. For instance, a user may configure a desired organization/arrangement of the categories of information to be presented by the entity-centric object. As an example, a user may configure the entity-centric object so as to define the relative arrangement of photographs, news, biographical information, and/or other categories of information to be presented by the entity-centric object.

According to certain embodiments of the present invention, the information contained in an entity-centric object dynamically updates. For instance, various techniques may be employed (e.g., by a maintainer) to search for information pertaining to an entity, and the information contained in the corresponding entity-centric object is updated to reflect newly discovered information. Such searching and updating techniques are preferably performed transparently from the user's perspective. That is, the user is not required to manually search for information about the entity in order to update the corresponding entity-centric object, but rather processes for searching for new information about an entity and dynamically updating the corresponding entity-centric object are preferably performed transparent to the user (e.g., in the background by the maintainer).

Also, according to certain embodiments of the present invention, the entity-centric objects are site-independent. That is, the entity-centric objects are not limited to a specific site, such as a specific website. For instance, the entity-centric objects are not limited to being accessible by a user via a specific website. As mentioned above, traditionally a discrete website may maintain information about one or more entities, thus enabling such information to be accessible to a user via the website. Unlike such a discrete website, entity-centric objects of an embodiment of the present invention do not require a user to access a given website in order to view the information contained therein. Thus, in this regard, the entity-centric objects are referred to herein as “site independent” (e.g., “website independent”) because the objects are not limited to being accessible via a single site (e.g., website). Instead, in certain embodiments, the entity-centric objects are nomadic and may effectively “follow” the user from site to site (e.g., from website to website). Thus, rather than requiring a user to access a given website in order to view the information contained in the entity-centric objects, the entity-centric objects can be available across a number of different websites (and/or other applications), thereby effectively following the user. In certain embodiments, information contained in an entity-centric object pertaining to a corresponding entity (e.g., corresponding named-entity) may be gathered from various informational sources, including as a subset thereof a given website that the user is currently visiting. Of course, in certain embodiments, an entity-centric object may be made available by a given site, such that a user may be required to access such given site in order to obtain the entity-centric object; but, once obtained by the user the entity-centric object is site independent. In certain embodiments, the entity-centric objects may not be available from site-to-site, but instead may be presented on one or more computers having an appropriate software application executing thereon (for presenting the entity-centric objects), such as on a given user's computer desktop.

According to certain embodiments, a plurality of entity-centric objects are made available for selection by a user from one or more sources, wherein the user can select those entity-centric objects that correspond to entities that are of interest to the user. That is, one or more sources may make entity-centric objects available for selection by a user. Thus, the user may identify entities that are of interest to the user, and the corresponding entity-centric objects may be obtained from a source and then used to facilitate the management of information about the entities of interest for the user. In this manner, the selected entity-centric objects may be considered as being “possessed” by a user. The entity-centric objects selected by a given user may be associated with the “possessing” user (e.g., via a user identifier). In certain embodiments, a limited number of entity-centric objects for a given entity may be available to users, while in other embodiments an unlimited number of entity-centric objects for a given entity may be available to users. For example, a limited-edition set of numbered entity-centric objects for a given named-entity may be made available to users in some embodiments, while in other embodiments an unlimited number of entity centric objects for a named-entity may be made available to users who are interested in such named-entity.

In one embodiment, the entity-centric objects may be presented to a user in the form of an electronic trading card (which may be referred to herein as a “ZoomCard™”). Traditional trading cards, such as baseball cards, are available that contain static information about a corresponding named-entity, such as a corresponding baseball player. One embodiment of the present invention employs a graphical presentation format similar to such a trading card for electronically displaying information contained in an entity-centric object to a user. Of course, other presentation formats may be defined for presenting the entity-centric objects in other embodiments.

As described further herein, in certain embodiments, any number of users can obtain (e.g., through purchase, free download, etc.) an entity-centric object from an authorized supplier (i.e., source) of such object, and thereby possess the entity-centric object. Preferably, the entity-centric objects for a given entity that are possessed by various users are all dynamically updated (e.g., by the maintainer) such that all of the objects contain updated information about the entity. Thus, the ZoomCards possessed by users for a given entity, for example, are all updated with up-to-date information about the given entity.

In certain embodiments, users may be charged a fee for obtaining the entity-centric objects, but in other embodiments some or all of the entity-centric objects may be available free of charge. Also, users may be required to provide certain information (e.g., demographic information) and/or agree to certain terms in order to obtain entity-centric objects. Advertising may be sold and presented on the entity-centric objects. Further, certain sources may negotiate to become an exclusive supplier of a particular entity-centric object. For instance, a given company may become the exclusive supplier of an entity-centric object for a celebrity that endorses the given company, whereby users are required to obtain the entity-centric object for the celebrity from the given company's website, for example.

A collection (or “portfolio”) of entity-centric objects may be possessed by a user for the various entities of interest to the user. In certain embodiments, users may define different collections (or “portfolios”) that contain the entity-centric objects selected by the user as belonging to each collection. In certain embodiments, such collections may be referred to as “decks” of ZoomCards. For example, a user may define a first collection named “My Favorite Sports Figures” in which the user's entity-centric objects for sports figures that are of interest to the user are arranged. The user may define another collection which the user names “My Politicians” in which the entity-centric objects of politicians possessed by the user are arranged. As another example, the user may define another collection which the user names “My Favorite Entertainment Celebrities” in which the entity-centric objects of entertainment celebrities (e.g., actors, actresses, etc.) possessed by the user are arranged.

Users may thus compile their own collection(s) of entity-centric objects for the entities that are of interest to them. Further, in certain embodiments, the entity-centric objects may notify a user when the information contained therein changes (e.g., when new information is received into the entity-centric object). In certain embodiments, a user may configure whether such notification is desired for a given entity-centric object, as well as configure a type of notification that is to be employed for the given entity-centric object. For instance, a variety of different types of notification may be available. One type of notification that may be available is a presentation of the object (e.g., a ZoomCard) graphically indicating a change in information. For example, a ZoomCard may move out of its “deck” of cards and/or flash and/or otherwise graphically indicate a change in information. Thus, the presentation of the entity-centric objects may change in some way to graphically indicate a change in information to the user. Other types of notifications that may be available alternatively or additionally include communicating a change in information through means external to the presentation of the entity-centric object, such as by emailing the user to notify of changed information, paging the user, calling the user and playing a recording notifying the user of the changed information, etc. Again, in certain embodiments, a user may configure the desired type of notification, if any, that is desired to be employed for each entity-centric object possessed by the user. Of course, different types of notifications may be employed for different entity-centric objects possessed by a user. For instance, a user may specify that no notification of updates is to be provided for certain entity-centric objects possessed by the user, while one or more of the above-mentioned notification techniques may be configured for notifying the user of updates to other entity-centric objects possessed by the user. Additionally, in certain embodiments, a user may specify which informational categories that updates are to trigger a notification. For instance, a user may specify that notification of updates to a “news” informational category of an entity-centric object possessed by the user is to trigger a notification of such update being sent to the user, while updates to a “photographs” informational category of the entity-centric object possessed by the user is not to trigger such a notification.

Thus, according to embodiments of the present invention, a user can specify entities of interest to the user, and entity-centric objects that contain dynamically updated information about the entity are thus associated with the user for use in facilitating the organization and presentation of information about the entity to the user. As a result, the burden of searching for information about an entity, filtering the information into categories of interest, organizing the information, and periodically updating the information is alleviated from the user. Instead, the user can simply obtain entity-centric objects corresponding to the entities of interest to the user, which present dynamically updated information about the entities to the user in a structured/organized manner.

According to certain embodiments, the entity-centric objects are capable of receiving user input. For instance, in certain embodiments, a presentation of an entity-centric object (e.g., a ZoomCard) may include a user-input portion for receiving input from a user, which is stored to the entity-centric object. As an example, in one embodiment, a ZoomCard may be “flipped over” to present a graphical representation of the back of the ZoomCard on which the user can input information. As another example, in another embodiment, a section may be reserved on the “front” of the presented ZoomCard for receiving user input thereto. In this manner, a user may input notes to an entity-centric object, which are stored into the entity-centric object possessed by the user and thus remain associated with the user's entity-centric object. Of course, a user may edit the input information (e.g., change, add, delete, or otherwise modify the information). While various informational categories may be maintained globally for a given entity's entity-centric object, such that all users possessing the given entity's entity-centric object have their respective objects dynamically updated with the global information, the user input to an entity-centric object possessed by the user may be stored locally (or remotely on the user's behalf) to that user's respective entity-centric object (and thus the user-input information may be private to that user).

According to certain embodiments, an entity-centric object may enable communication between users possessing the entity-centric object. For instance, a “chat” feature may be implemented for an entity-centric object that enables different users that possess a given entity's entity-centric object to exchange information with each other. In this manner, the entity-centric object may provide a communication platform that effectively brings together users who are interested in a given entity and enables the users to exchange information, without requiring that the user's go to any specific site (e.g., website) to find other persons interested in a given entity.

Further still, in certain embodiments, information about the users, such as demographic information, may be captured by the source of the entity-centric objects. Further, in certain embodiments, various statistical information may be maintained by the source of the entity-centric objects, such popularity of a given entity (e.g., how many users possess the given entity's entity-centric object), relationships between entities (e.g., an indication of how many users who possess an entity-centric object for entity A also possess an entity-centric object for entity B), etc.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1A shows an exemplary system according to one embodiment of the present invention, wherein a presentation of a collection of entity-centric objects is presented to a user;

FIG. 1B shows another exemplary system according to an embodiment of the present invention, wherein a presentation of a plurality of user-defined collections of entity-centric objects are presented to a user;

FIGS. 2A-2B illustrate exemplary techniques that may be employed for enabling a user to obtain entity-centric objects (e.g., through a user registration process) according to embodiments of the present invention;

FIG. 3 shows an exemplary system illustrating how a registered user may obtain entity-centric objects according to one embodiment of the present invention;

FIG. 4 shows an example of using entity-centric objects to facilitate management of desired information according to one embodiment of the present invention;

FIGS. 5A-5B shows exemplary implementations of using entity-centric objects to facilitate management of desired information, wherein presentation of information contained in the entity-centric objects is site-independent and nomadic;

FIG. 6 shows an example of one embodiment for dynamically updating the information (or “content”) of entity-centric objects via performance of tasks that are transparent to users possessing the entity-centric objects;

FIG. 7 shows an exemplary operational flow according to an embodiment of the present invention;

FIG. 8 shows another exemplary operational flow according to an embodiment of the present invention;

FIG. 9 shows an exemplary presentation of an entity-centric object according to one embodiment of the present invention; and

FIGS. 10A-10J show an exemplary user interface according to one embodiment of the present invention.

### DETAILED DESCRIPTION OF THE INVENTION

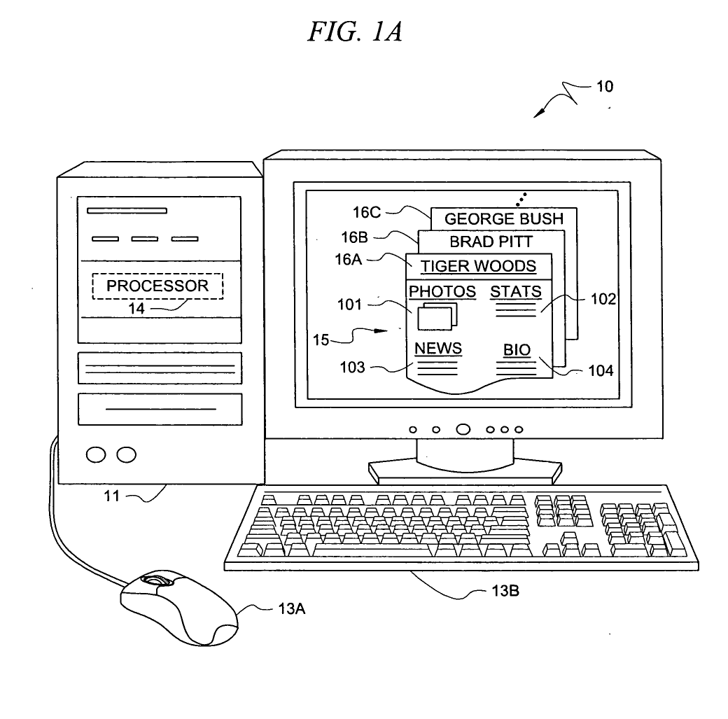

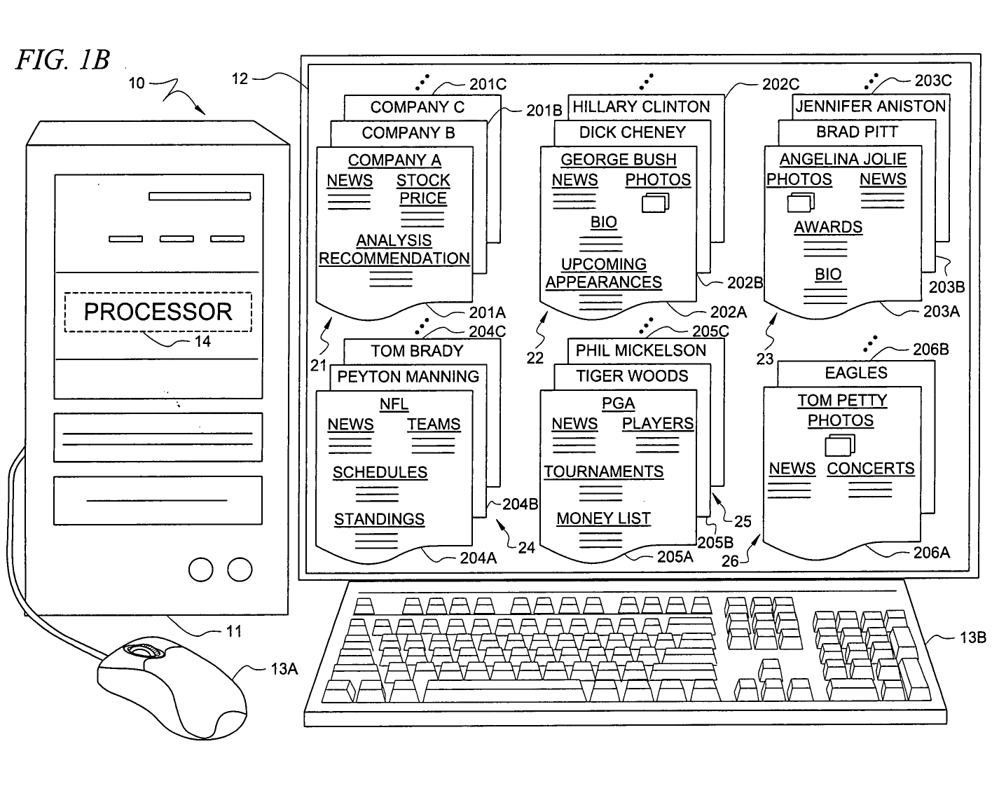

FIG. 1A shows an exemplary system 10 according to one embodiment of the present invention. System 10 shows an exemplary computing device, which in this example is shown as a personal computer (PC) 11, but could likewise be any other computing device, such as a laptop computer, cellular telephone, personal digital assistant (PDA), etc., that comprises a processor, such as processor 14, for executing the tasks described further herein. The computing device may comprise user input and output devices. For instance, as is well-known in the art, PC 11 may comprise user input devices, such as mouse 13A and/or keyboard 13B, and user output devices, such as speakers (not shown) and display 12.

As described further herein, a software application executes (e.g., either locally on PC 11 and/or remotely on another computing device, such as a server, to which PC 11 is communicatively coupled) to manage entity-centric objects. A user interface may be used to present information contained in the entity-centric objects to a user. The information may be structured/organized in a manner specified by the entity-centric object. In the example of FIG. 1A, a collection 15 of entity-centric objects is presented via display 12. In this example, the entity-centric objects are presented as ZoomCards, and the collection 15 may thus be referred to as a “deck” of such cards. Thus, the information contained in an entity-centric object can be presented in a structured/organized manner to a user, e.g., via a corresponding ZoomCard or other output presentation utilized.

In the example of FIG. 1A, the collection 15 of entity-centric objects includes entity-centric objects for various named-entities, such as entity-centric object 16A pertaining to Tiger Woods, entity-centric object 16B pertaining to Brad Pitt, and entity-centric object 16C pertaining to George Bush. Thus, the named-entities in the example of FIG. 1A are Tiger Woods, Brad Pitt, and George Bush, and the respective entity-centric objects for each of these named-entities maintains information about their corresponding named-entity. In this example, the user has selected these named-entities as being of interest to the user, and has thus obtained the corresponding entity-centric objects 16A-16C from a source. Exemplary techniques for obtaining such entity-centric objects are described further below.

The exemplary entity-centric object 16A shown in FIG. 1A contains various informational categories about Tiger Woods that is presented to the user in a structured/organized manner, such as photograph(s) 101, statistics 102, news 103, and biographical information 104. Informational categories may be similarly maintained and presented for the other named-entities. Of course, the informational categories defined (e.g., by a publisher) for different types of named-entities may differ. For instance, certain informational categories may be defined for entity-centric objects about sports entities (e.g., Tiger Woods), and other informational categories may be defined for entertainment celebrities (e.g., Brad Pitt), political figures (e.g., George Bush), musicians, companies, etc. Thus, for a named-entity of a given type, such as sports figures, political figures, movie stars, musicians, companies, etc., respective informational categories may be defined, including without limitation one or more of biographical information, pictorial information, video information, filmography, resume, professional statistics, relationships to other named-entities, etc.

In certain embodiments, users may define different collections (or “portfolios”) that contain the entity-centric objects selected by the user as belonging to each collection. In certain embodiments, such collections may be referred to as “decks” of ZoomCards. Turning to FIG. 1B, an example in which a user has a plurality of collections of entity-centric objects is provided. In the example of FIG. 1B, a user has collections (or “decks”) 21-26. Collection 21 may be named “Companies of Interest”, for example, and contains entity-centric objects 201A-201C for different companies, shown as Companies A-C, respectively. Collection 22 may be named “Politicians of Interest”, for example, and contains entity-centric objects 202A-202C for different political figures, such as George Bush, Dick Cheney, and Hillary Clinton. Collection 23 may be named “Entertainment Celebrities of Interest”, for example, and contains entity-centric objects 203A-203C for different entertainment celebrities, such as Angelina Jolie, Brad Pitt, and Jennifer Aniston. Collection 24 may be named “Football Entities of Interest”, for example, and contains entity-centric objects 204A-204C for different football entities, such as the National Football League (NFL) organization, as well as individual football players Peyton Manning and Tom Brady. Collection 25 may be named “Golf Entities of Interest”, for example, and contains entity-centric objects 205A-205C for different golf entities, such as the Professional Golf Association (PGA) organization, as well as individual golfers Tiger Woods and Phil Mickelson. Collection 26 may be named “Musicians of Interest”, for example, and contains entity-centric objects 206A-206B for different musicians, such as Tom Petty and the Eagles. Exemplary informational categories are shown for the ZoomCards 201A, 202A, 203A, 204A, 205A, and 206A. Of course, the informational categories shown are merely illustrative and a publisher may define additional and/or different informational categories for a given entity-centric object.

Thus, in the example of FIG. 1B, the user has obtained (from one or more sources) entity-centric objects for a variety of different named-entities that are of interest to the user, and the user has organized the entity-centric objects into respective collections. Organizing the objections into such user-defined collections may be desirable for various reasons. For instance, such organization may enable a user to more easily browse and find the cards of interest when the user possesses many cards. As another example, such organization enables a user to create a personalized grouping of named-entities that is not recognized as a related grouping globally (e.g., in the real world). For instance, a user who has a team in a fantasy football league may organize a group of entity-centric objects for football players into a collection of “My Fantasy Football Team”, wherein the grouping of the football players from various different teams as a single collection may have little or no meaning globally, but the user is capable of organizing such named-entities into a personalized group that has meaning to the user (e.g., the user's fantasy football team). As another example, such organization enables different groupings of cards to be managed differently. For instance, in certain embodiments, a user may define different public rights to information about different groups of cards possessed by the user. For example, a user may define (e.g., in the user's profile) that information about the user's possession of cards of certain groups (e.g., “My Public Cards”) defined by the user can be published (e.g., others can be informed that the user possesses these cards), while sharing/display of other groups of cards possessed by the user may not be so publicized (e.g., others cannot discover that the user possesses these cards). For instance, a user may make publicly available which cards about celebrities and sports figures the user possesses, but the user may keep cards possessed for certain political figures private.

It should be noted that the number of different collections, the number of entity-centric objects contained in each collection, and the exemplary entity-centric objects and corresponding informational categories shown for each object in FIGS. 1A-1B are intended merely as illustrative examples, and embodiments of the present invention are not limited to any such number of collections and/or entity-centric objects or as to the specific entity-centric objects and informational categories shown.

As mentioned above, the information contained in an entity-centric object may be dynamically updated (e.g., by a maintainer) in a manner that is transparent to a user (e.g., that does not require a user to search for, obtain, and update the entity-centric object with such information). Exemplary techniques that may be employed for dynamically updating entity-centric objects according to certain embodiments of the present invention are described further below.

Also, as described further below, in certain embodiments the entity-centric objects are site-independent. Further, the entity-centric objects may be nomadic, and thus follow a user from site to site. Examples of such site-independent and nomadic entity-centric objects are described further below.

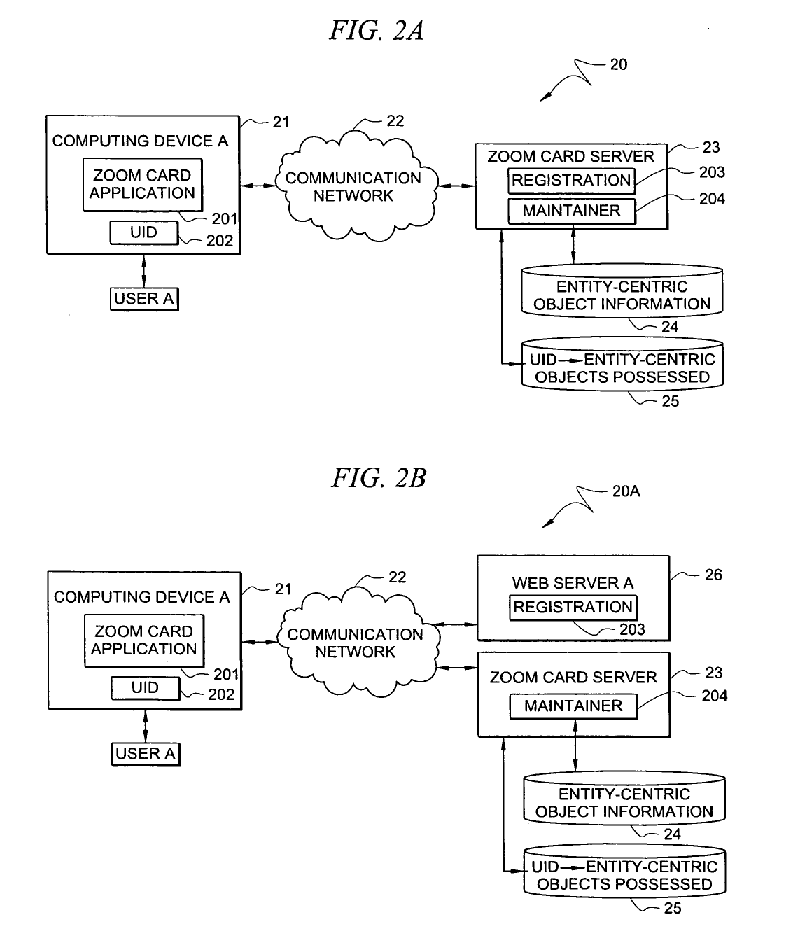

Turning to FIGS. 2A-2B, exemplary techniques that may be employed for enabling a user to obtain entity-centric objects according to embodiments of the present invention are described. FIG. 2A shows an exemplary system 20 that comprises a user's computing device 21, such as PC 11 of FIG. 1, that is communicatively coupled to communication network 22, which may be the Internet or other wide-area network (WAN), a local-area network (LAN), public-switched telephone network (PSTN), wireless network, any combination of the foregoing or any other network now known or later developed that permits computing devices to exchange information. System 20 also comprises a source 23 (shown in this example as a ZoomCard server, which may be referred to as ZoomCard Central) that enables a user to get setup for obtaining entity-centric objects according to one embodiment of the present invention. In this example, the source 23 comprises a maintainer 204 that executes to maintain information about published entity-centric objects in database 24. Exemplary techniques that may be employed for maintaining such information are described later herein.

In certain embodiments, a user undergoes a registration process before being allowed to obtain entity-centric objects. The registration process may be a one-time process, which once completed enables the user to obtain any number of published entity-centric objects that may be available. For instance, according to the exemplary embodiment of FIG. 2A, a user undergoes a registration process 203 with the ZoomCard server 23 to get setup for obtaining entity-centric objects. As part of the registration process 203, the ZoomCard server 23 assigns a unique user identification (UID) 202 to the user. The ZoomCard server 23 may also allow the user to establish a password associated with the UID. Further, the ZoomCard server 23 may also, as part of the registration process 203, collect demographic information about the user. Further, the ZoomCard server 23 may enable the user to establish a profile which specifies, for example, gender, age, hobbies/interests, income profile, city of residence, and/or other demographic information about the user. Also, an entity-centric object manager (e.g., ZoomCard application) 201 may be downloaded from the ZoomCard server 23 to the computing device 21 as part of registration process 203. The manager 201 is operable to, for example, present a user interface for displaying the information contained in the entity-centric objects possessed by the user. Further, the manager 201 may keep a local storage/database of a list of the ZoomCards possessed by the user and the information contained on each card, which acts as a cached version of the information when the user is not communicatively coupled to ZoomCard server 23 (e.g., is offline), and such cached version of information is updated by interacting with ZoomCard server 23 when the user is online.

Once registered, a user may select entities that are of interest to the user and obtain the corresponding entity-centric objects. In this example, ZoomCard server 23 maintains a relationship of UIDs and the corresponding entity-centric objects possessed by each UID. For instance, such relationship of UIDs and possessed entity-centric objects may be maintained via a relational database 25. Thus, for instance, user A assigned UID 202 in FIG. 2A may obtain various entity-centric objects for entities selected by the user as being of interest, and server 23 maintains a relationship (e.g., in database 25) that identifies those entity-centric objects that are possessed by user A. Further, in certain embodiments, a user may interact with server 23 to define a plurality of collections (or “decks” of ZoomCards), and the defined collections, as well as the respective entity-centric objects contained in each collection, may be related to the user's UID by database 25.

FIG. 2B shows another exemplary registration technique according to an embodiment of the present invention. FIG. 2B shows an exemplary system 20A that comprises a user's computing device 21, such as PC 11 of FIG. 1, that is communicatively coupled to communication network 22, as in the example of FIG. 2A. System 20A also comprises a source 23 (shown in this example as a ZoomCard server) that comprises a maintainer 204 that executes to maintain information about published entity-centric objects in database 24. System 20A further comprises a web server 26 that enables a user to get setup for obtaining entity-centric objects according to one embodiment of the present invention.

In this example, a web server 26 enables a user to register for obtaining entity-centric objects. For instance, web server 26 may be a supplier (e.g., an exclusive or non-exclusive supplier) of one or more entity-centric objects, and if user A accesses the web server's website desiring to obtain one or more of the entity-centric objects, the web server 26 may determine whether the user A has previously registered for obtaining entity-centric objects. That is, the web server 26 may determine whether the user A has been assigned a UID. Web server 26 may make such determination itself if it possesses a list of registered users, or it may send a request to ZoomCard server 23 to determine whether user A has been assigned a UID. If the user has registered, the UID stored locally to the user's computing device 21 may be sent to the web server 26, and the web server 26 may access ZoomCard server 23 to verify that the UID is a valid UID (e.g., is included in database 25). If the user has previously registered, but is not using a computing device to which the UID is stored (e.g., is using a different computing device than was used when registering), the user may be afforded an opportunity to input a UID and password, which web server 26 may then verify with server 23.

If determined that the user does not possess a valid UID, then the web server 26 may provide a link to server 23 so that the user can undergo the registration process 203 in the manner described above with FIG. 2A. Alternatively, the web server 26 may itself conduct the above-described registration process 203, and may supply the registration information to server 23 (e.g., for establishing the user as a valid user and storing the user's UID to database 25). Additionally, web server 26 may collect additional information and/or impose additional terms for registration in order for the user to obtain one or more of the entity-centric objects supplied by the web server 26.

Once registered, the user may select the entities that are of interest to the user and obtain the corresponding entity-centric objects that are supplied by web server 26. Web server 26 may notify ZoomCard server 23 of any such entity-centric objects obtained by the user via web server 26 such that ZoomCard server 23 can maintain a relationship of UIDs and the corresponding entity-centric objects possessed by each UID (e.g., via database 25).

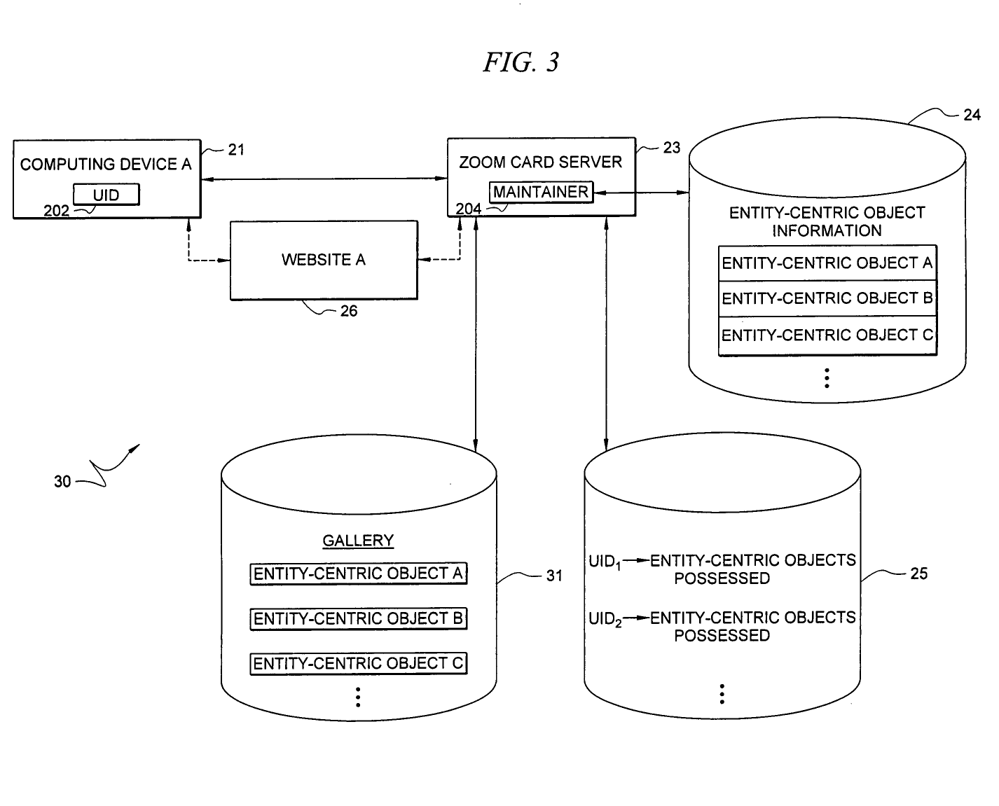

FIG. 3 shows an exemplary system 30 according to one embodiment illustrating how a registered user may obtain entity-centric objects according to one embodiment of the present invention. In this example, ZoomCard server 23 is again shown, which is communicatively coupled to database 24 (in which maintainer 204 maintains information for published objects) and database 25 (which relates UIDs to respective entity-centric objects possessed), as in FIGS. 2A-2B above. In this example, a gallery 31 of published entity-centric objects may be available, which identifies published entity-centric objects that are available to registered users. Thus, for instance, a registered user may use computing device 21 to access ZoomCard server 23 (via communication network 22) and view gallery 31 to discover the entity-centric objects that are available. Alternatively, in certain embodiments, a registered user may use computing device 21 to access (via communication network 22) a website 26, which interfaces with ZoomCard server 23 to present the user with gallery 31 so that the user can discover the entity-centric objects that are available. The user may select those entities that are of interest to the user, and the user's UID is updated in database 25 to indicate those selected entities. In this manner, the user's UID is related to the selected entity-centric objects, which are considered as being possessed by the corresponding user.

Gallery 31 may thus be implemented as a central repository of published entity-centric objects. In certain embodiments, gallery 31 may just identify the objects that have been published, and the information contained in each object may be stored in database 24. In other embodiments, gallery 31 and database 24 may be integrated together. Gallery 31 (and/or database 24) may be any suitable type of data storage, such as one or more servers on a distributed content network (e.g., the AKAMAI distributed content network and storage capabilities), for example.

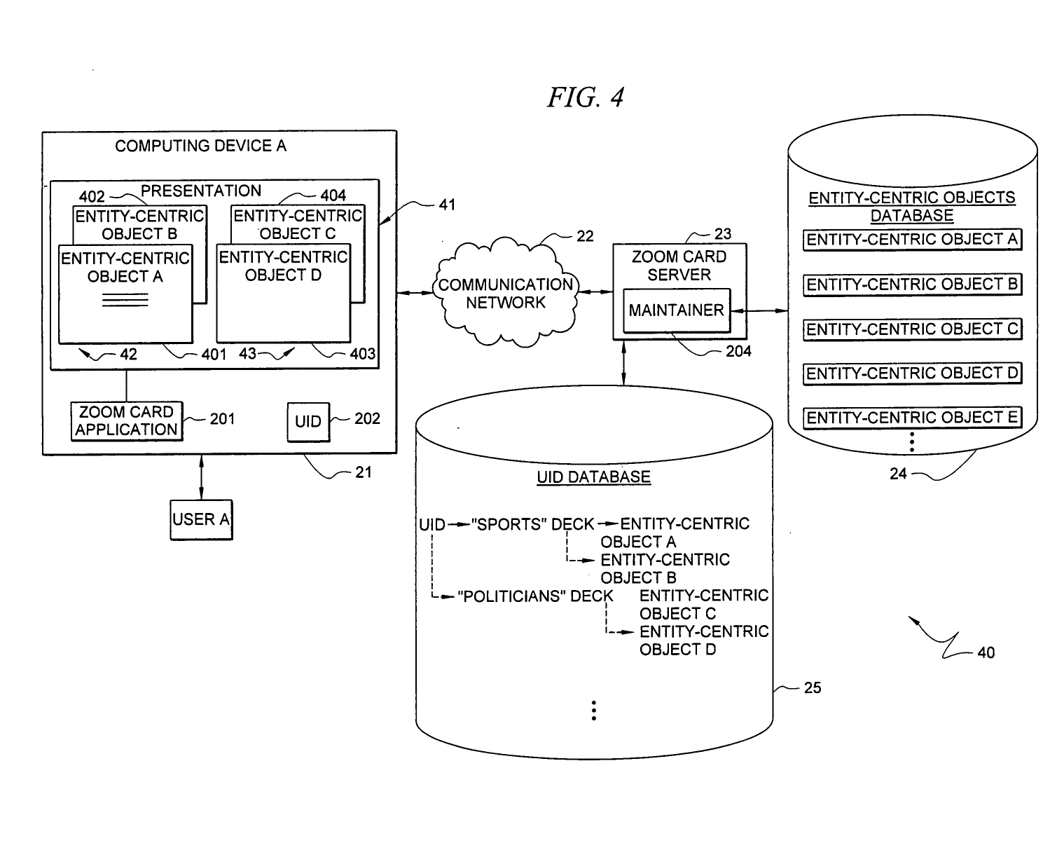

Turning to FIG. 4, one example of using entity-centric objects to facilitate management of desired information according to one embodiment of the present invention is shown. In the exemplary system 40, computing device 21 is communicatively coupled via communication network 22 to ZoomCard server 23. In this example, user A has registered with ZoomCard server 23 (e.g., via one of the techniques described above with FIGS. 2A-2B), and thus UID 202 is associated with the user. The user has further created two collections (or “decks”) of entity-centric objects, which are related to the user's UID in UID database 25. In the illustrated example, a “Sports” Deck is associated with the UID, in which the user has obtained and placed entity-centric objects A and B; and a “Politicians” Deck is associated with the UID, in which the user has obtained and placed entity-centric objects C and D. Thus, UID database 25 relates the decks and entity-centric objects contained in each deck to the corresponding UID.

The user's UID 202 is communicated to ZoomCard server 23, and ZoomCard server 23 determines from UID database 25 those collections of entity-centric objects possessed by the user. The ZoomCard server 23 retrieves the information maintained for each of the determined entity-centric objects from database 24, and returns that information to computing device 21, wherein ZoomCard Application 201 executes on computing device 21 to present the information to the user (e.g., as in the examples shown in FIGS. 1A-1B). In this example, ZoomCard Application 201 generates a graphical presentation 41 (e.g., to a display, such as display 12 of FIGS. 1A-1B) in which two decks of ZoomCards are presented. A first deck 42 corresponds to the user-defined “Sports” deck, and thus presents ZoomCards 401 and 402 for the entity-centric objects A and B, respectively. Such entity-centric objects A and B may correspond to user-selected sports figures, such as Tiger Woods, etc. The second deck 43 corresponds to the user-defined “Politicians” deck, and thus presents ZoomCards 403 and 404 for the entity-centric objects C and D, respectively. The entity-centric objects C and D may correspond to user-selected political figures, such as those shown in deck 22 of FIG. 1B for example. As described further hereafter, maintainer 204 may dynamically update the information contained in entity-centric objects, and such updated information may be sent to the respective users determined by server 23 (from database 25) as possessing the entity-centric objects that have updated information. Further, when such an update is received, ZoomCard Application 201 may cause a notification of the update to the user, such as by graphically indicating an update to a ZoomCard on presentation 41, and/or via other notification methods mentioned herein.

Also, in certain embodiments, user-input information (e.g., notes) is associated with a user's respective entity-centric object. For instance, the user interface may enable a user to input information, which is associated with the user's possessed entity-centric object. When the user is offline (e.g., not communicatively coupled to ZoomCard server 23), the user-input information may be stored locally (e.g., in a database on the user's computer) until the user's computer is online once again. When online, the user-input information that is stored locally (while offline) and/or that is input while online is communicated to ZoomCard server 23 for storage to a central database and associated with the respective ZoomCard possessed by the user. Thus, such user-input information is available to the user wherever, whenever the user is online, such that any notes (or other user-input information) stored to the ZoomCard server 23 for a user's given ZoomCard can remain associated with such ZoomCard and viewed from various sites.

Additionally, according to certain embodiments of the present invention, the entity-centric objects are site-independent. That is, the entity-centric objects are not limited to a specific site, such as a specific website. For instance, the entity-centric objects are not limited to being accessible by a user via a specific website. Entity-centric objects of an embodiment of the present invention thus do not require a user to access a given website in order to view the information contained therein. Instead, in certain embodiments, the entity-centric objects are nomadic and may effectively “follow” the user from site to site (e.g., from website to website). Thus, rather than requiring a user to access a given website in order to view the information contained in the entity-centric objects, the entity-centric objects can be available across a number of different websites (and/or other applications), thereby effectively following the user.

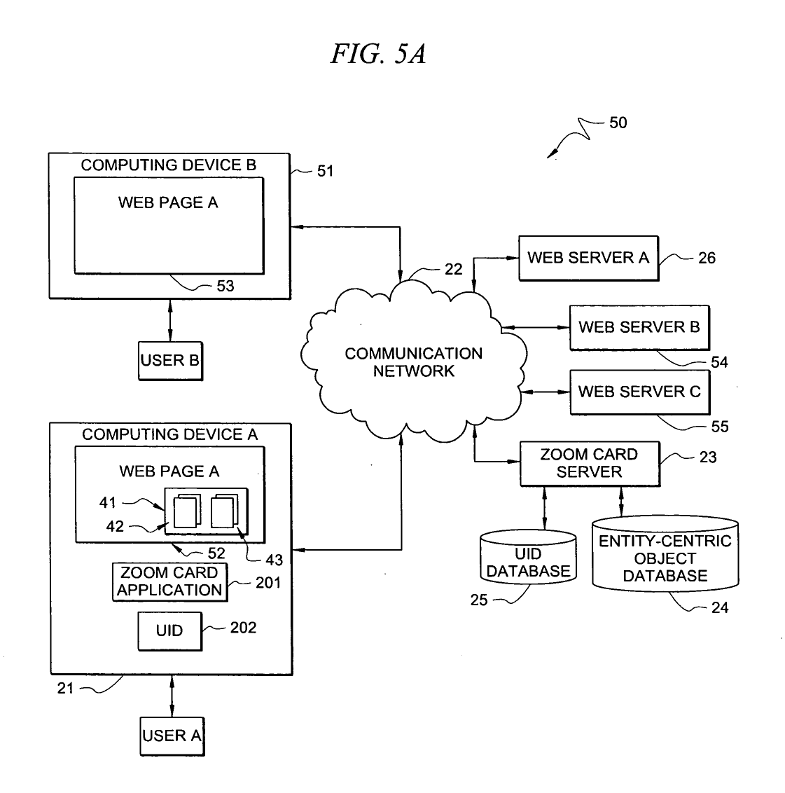

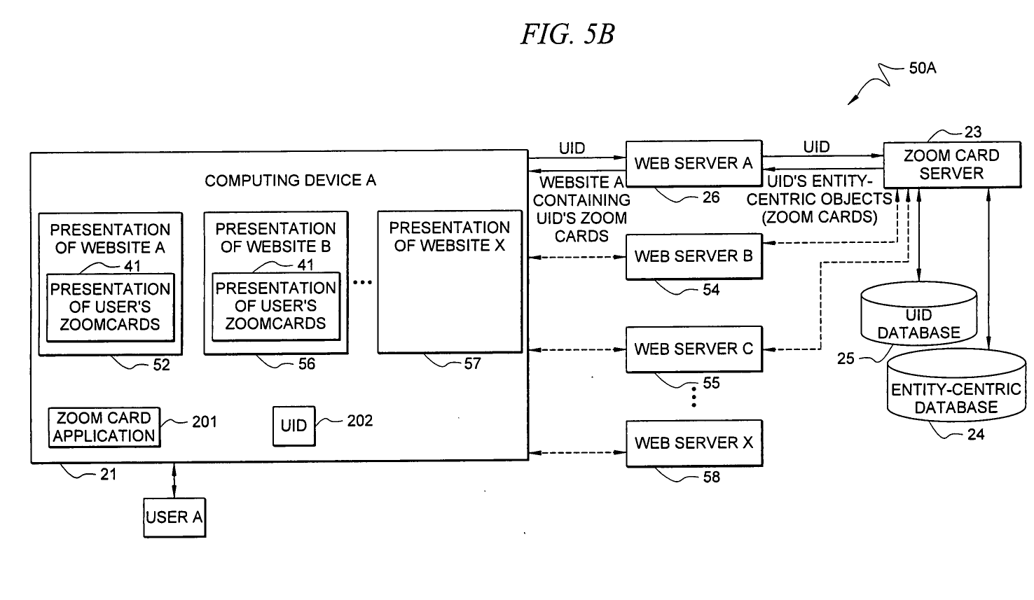

Turning to FIGS. 5A-5B, exemplary implementations of such site-independent, nomadic, entity-centric objects are shown. FIG. 5A shows an exemplary system 50 that comprises computing device 21, which may communicatively couple via communication network 22 to any of a number of different web servers, such as web servers 26, 54, and 55, and/or to ZoomCard server 23. In the illustrated example, user A has registered with ZoomCard server 23 (e.g., via one of the techniques described above with FIGS. 2A-2B), and thus UID 202 is associated with the user in UID database 25, such as in the example discussed above with FIG. 4. Further, in the illustrated example, user A accesses, via communication network 22, web server 26 and is thus presented the web page A (i.e., the web page served by web server 26) in a presentation 52. Such web page may be presented in a traditional manner, e.g., via a web browser application, to a display, such as display 12 of FIGS. 1A-1B.

Further, in this example, the UID 202 is communicated to web server 26, and web server 26 communicates the received UID (via communication network 22) to ZoomCard server 23 to verify that it is a valid UID and, if so, to receive the entity-centric objects associated with the UID. In this case, server 23 looks the UID up in database 25 and determines that the UID is a valid UID. Server 23 thus determines the collections of entity-centric objects that are associated with the UID, and returns those collections of entity-centric objects to web server 26. That is, the information contained in database 24 for each of the entity-centric objects determined to be possessed by the user is returned to the web server 26. As a result, web server 26 can include presentation 41 of the user's collections (e.g., presenting decks 42 and 43, as in FIG. 4 above) as part of web page A. Web server 26 may thus be considered as “ZoomCard Adaptable” by virtue. In other words, web server 26 may code its web pages to adapt the presentation of such web pages to include a recognized user's ZoomCards.

Similarly, other websites that the user may access which are configured to recognize the UID and interact with ZoomCard server 23 in the above manner may likewise present the user's ZoomCard decks. Accordingly, the user's decks are site-independent and can appear to the user to be nomadic in that they effectively follow the user from site to site.

Additionally, in certain embodiments, the ZoomCard application 201 executing locally on the user's computer may operate to modify a web page that is presented by a web server that is not adaptable in the above-mentioned manner. For instance, certain web servers may not cooperate with ZoomCard Server 23 and/or may not code its web pages as to adapt to present a recognized user's ZoomCards. In such cases, ZoomCard application 201 may operate to modify the presentation of information from such a website so as to include the user's ZoomCards in the presentation of the website. An example of a known locally-executable application that is capable of modifying the HTML code of a web page being presented on a local browser in this manner is commercially known as Greasemonkey. For instance, ZoomCard application 201 may intercept HTML code received from a non-cooperative web server and modify the HTML code to present the user's ZoomCards via a browser that is executing on the user's local computer. Thus, when the modified HTML code is forwarded on to the user's local browser, the web page is modified so as to include the user's ZoomCards. Further, in certain embodiments, the ZoomCard application 201 may scan the HTML code received from a web server for the presence of data pertaining to a named-entity corresponding to a named-entity for which the user possesses a ZoomCard, and the ZoomCard application 201 may modify the HTML code to present the corresponding ZoomCard(s) for any such detected named-entities (e.g., the ZoomCards may be arranged on the web page in the vicinity of the detected data relating to the corresponding named-entity).

Also shown in FIG. 5A is a computing device 51 of a user who has not registered with ZoomCard server 23 and thus does not have a valid UID. As such, when user B accesses web server 26, the user is presented with a presentation 53 of web page A, which does not include a presentation of the user's ZoomCards (as the user does not possess such ZoomCards). Of course, upon determining that the user is not a registered user, the user may be presented an opportunity to become a registered user in the manner described above.

Also, in certain embodiments, those web servers that cooperate with ZoomCard server 23 support the presentation of registered users' ZoomCards on their respective websites, while web servers that do not cooperate with ZoomCard server 23 may not support such presentation. Thus, in certain embodiments, the ZoomCards possessed by a user may not be available on all sites, but may be available on all sites that cooperate with ZoomCard server 23. For instance, FIGURE SB shows an exemplary system 50A that again comprises computing device 21, which may communicatively couple (e.g., via communication network 22 of FIG. 5A) to any of a number of different web servers, such as web servers 26, 54, 55, and 58 and/or to ZoomCard server 23. As with the above example of FIG. 5A, in this illustrated example, user A has registered with ZoomCard server 23 (e.g., via one of the techniques described above with FIGS. 2A-2B), and thus UID 202 is associated with the user in UID database 25, such as in the example discussed above with FIG. 4.

In the illustrated example, user A accesses (e.g., via communication network 22) web servers 26, 54, 55, and 58. Web servers 26, 54, and 55 cooperate with ZoomCard server 23, while web server 58 does not. According, when accessing web server 26, the UID 202 is communicated to web server 26, and web server 26 communicates the received UID (via communication network 22) to ZoomCard server 23. ZoomCard server 23 verifies that the received UID is a valid UID, and receives the entity-centric objects associated with the UID. ZoomCard server 23 returns to web server 26 the collection(s) of entity-centric objects associated with the UID. As a result, web server 26 can include presentation 41 of the user's collections (e.g., presenting decks 42 and 43, as in FIG. 4 above) as part of web page A.

Similarly, the other websites that cooperate with the ZoomCard server 23 (e.g., which are configured to recognize the UID and interact with ZoomCard server 23 in the above manner), such as web servers 54 and 55 in the illustrated example, may likewise present the user's ZoomCard decks. For instance, presentation 56 of website B served from web server 54 may likewise include presentation 41 of the user's ZoomCards. However, in this example, web server 58 does not cooperate with ZoomCard server 23, and thus presentation 57 of website X served from web server 58 does not include the presentation of the user's ZoomCards. Accordingly, the user's decks are site-independent and can appear to the user to be nomadic in that they effectively follow the user from site to site; although, in this exemplary implementation the presentation of the decks may not be available on all sites, but instead may be available only on those sites that cooperate with the ZoomCard server 23.

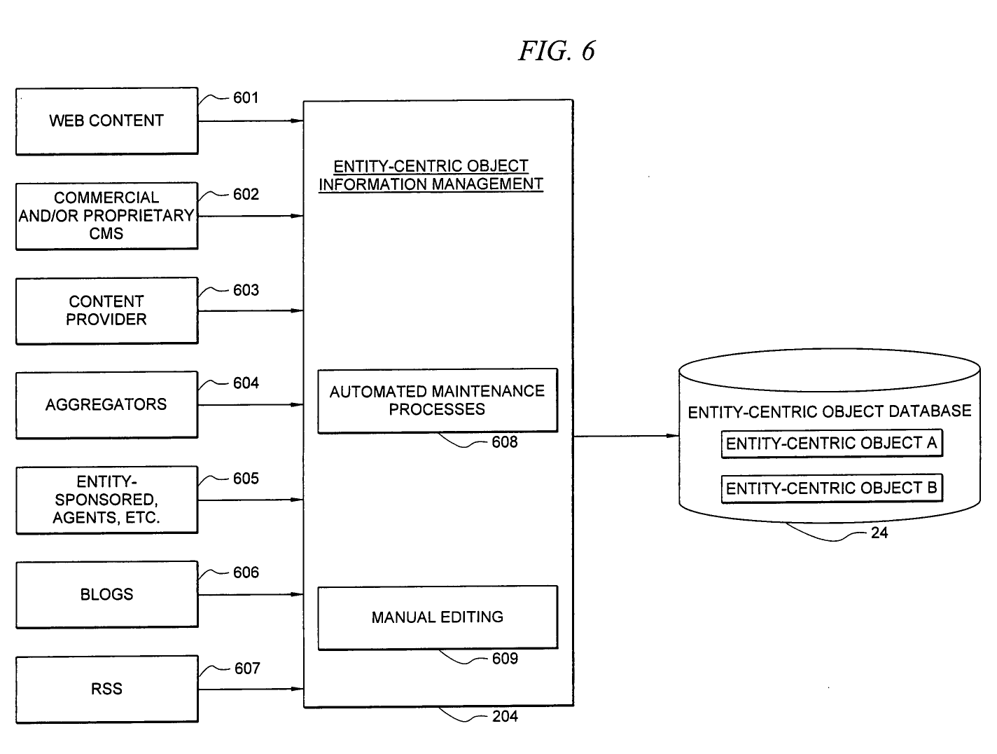

As mentioned above, in certain embodiments, a maintainer 204 dynamically updates the information contained in each entity-centric object via actions that are transparent to the user. An example of one embodiment for dynamically updating the information (or “content”) of entity-centric objects is shown in FIG. 6. FIG. 6 shows an example of a maintainer 204 that performs various tasks for managing information of entity-centric objects, such as collecting information, relating collected information to a corresponding entity to which it relates, aggregating information (e.g., to avoid duplicative information), filtering information (e.g., filtering information that is not maintained in any category defined for the entity's entity-centric object), and/or updating the information contained in the respective entity-centric object, as examples. As shown, various tasks may be automated and performed by automated maintenance processes 608.

First, when updating information for entity-centric objects, information about entities is periodically collected from a number of different informational sources, such as informational sources 601-607. Informational source 601 is web content. Informational source 602 is commercial and/or proprietary feeds. Informational source 603 is content providers, and informational source 604 is other aggregators of information. Informational source 605 is entity-sponsored sources (e.g., the named entities or their agents themselves). Informational source 606 is blogs, and informational source 607 is RSS feeds.

Information may be collected from the various informational sources (e.g., by maintainer 204) using various techniques, including automated collection techniques. For example, maintainer 204 may collect information from web content 601 and/or from blogs 606 via web crawlers and/or searching robots, as is well-known in the art. Maintainer 204 may collect information from commercial and/or proprietary feeds 602, content providers 603, and/or other aggregators of information 604 via data feeds (e.g., XML), for example, in a manner well-known in the art. Maintainer 204 may collect information from entity-sponsored sources 605 via text files, transcripts, photos, email communication, and/or other data feeds, as examples, as is well-known in the art.

In certain embodiments, various maintenance tasks may be performed manually, such as manual editing tasks 609. For example, an editor may manually create information (e.g., obtained from an interview with an entity or the entity's representative) to be included in the entity's entity-centric object. Such created information may not otherwise be publicly available, but may, in some instances, be exclusively available via the entity-centric object.

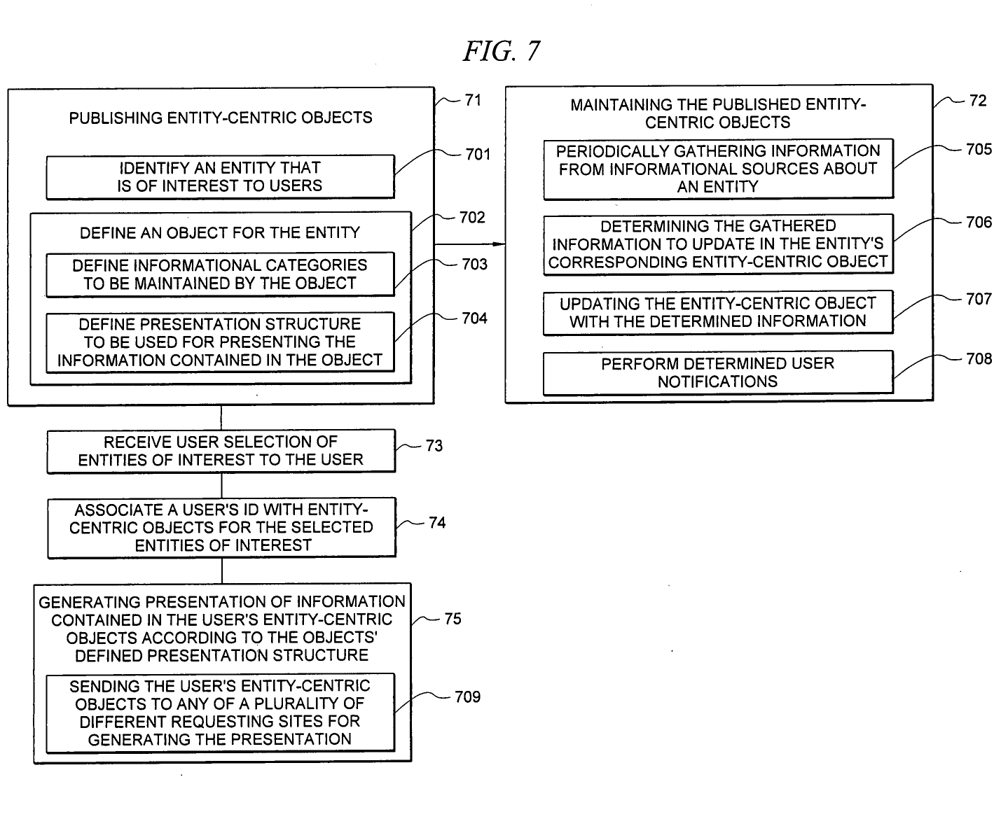

FIG. 7 shows an exemplary operational flow according to certain embodiments of the present invention. In operational block 71, a publisher publishes entity-centric objects. As part of such publishing, the publisher may identify an entity that is of interest to users (in block 701), and define an object for the identified entity (in block 702). In defining the object for an entity, the publisher may define, in block 703, informational categories to be maintained by the object, such as photographs, news, biographical information, upcoming dates of interest, statistics, etc. Further, in block 704, the publisher may define a presentation structure to be used for presenting the information contained in the object. Such presentation structure may, for instance, define a graphical presentation object (such as a trading card, e.g., ZoomCard), as well as the relative arrangement of information contained in each of the informational categories to be presented on the graphical presentation object (e.g., define the layout of the information). In certain embodiments, users may be permitted to modify/configure the presentation structure so as to arrange the presentation of information in a manner preferred by the user. The defined entity-centric objects may then be stored to a repository, such as to database 24.

In operational block 72, a maintainer maintains information for the defined informational categories of entity-centric objects. That is, the maintainer periodically updates the information to maintain the information current (i.e., up-to-date). As part of such maintaining, a maintainer may periodically gather information from informational sources (e.g., informational sources 601-607 of FIG. 6) about an entity, in block 705. In block 706, the maintainer may determine the gathered information that is to be used in updating an informational category of the entity's corresponding entity-centric object. In block 707, the entity-centric object is updated to include the determined information (e.g., in the corresponding informational category of the object). And, in block 708, the maintainer may determine those users who possess the updated entity, and may notify one or more of such users of the updates (e.g., according to user-configured notification policies).

Also, once entity-centric objects are published in block 71, a user may select the corresponding entity as being of interest to the user. For instance, in block 73, a source may receive a user selection of entities that are of interest to the user. As described above, the user may define one or more collections (e.g., decks) of user-selected entities that are of interest. In block 74, the source associates a user ID with the corresponding entity-centric objects of the user-selected entities. For instance, a relationship between UIDs and entity-centric objects of user-selected entities may be maintained in a database 25, as discussed above.

In block 75, a presentation of information contained in the user's entity-centric objects may be generated according to the objects' respective presentation structure. As discussed above, in certain embodiments, such presentation may be site-independent. Thus, for instance, in block 709, the source (e.g., ZoomCard server 23) may send the user's entity-centric objects to any of a plurality of different requesting sites for generating the presentation.

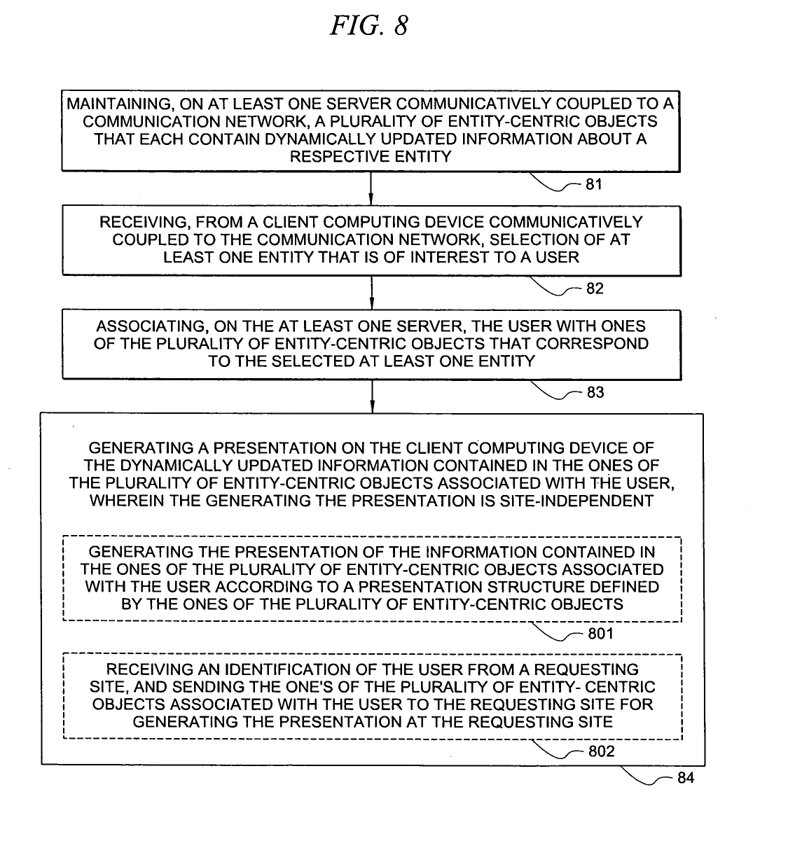

Turning to FIG. 8, an exemplary operational flow of one embodiment of the present invention is shown. In operational block 81, a plurality of entity-centric objects that each contain dynamically updated information about a respective entity are maintained on at least one server (e.g., ZoomCard server 23 described above, or other source) that is communicatively coupled to a communication network (e.g., communication network 22 described above). In block 82, a selection of at least one entity that is of interest to a user is received by the at least one server (or “source”) from a client computing device (e.g., computing device 21 described above) that is communicatively coupled to the communication network. In block 83, the at least one server (or “source”) associates the user with ones of the plurality of entity-centric objects that correspond to the entity(ies) selected by the user. For instance, such an association may be made via the above-described UID database 25. In block 84, a presentation is generated on the client computing device presenting the dynamically updated information contained in the ones of the plurality of entity-centric objects associated with the user. Further, as described above, the generating of the presentation is site-independent (e.g., it can be generated at a plurality of different websites).

In certain embodiments, generating the presentation may further comprise one or more of the operational blocks 801 and 802. In operational block 801, the presentation of information contained in the ones of the plurality of entity-centric objects associated with the user presents such information according to a presentation structure defined by the respective objects. In block 802, an identification of the user is received by the at least one server (or “source”) from a requesting site, and the at least one server (or “source”) sends the ones of the plurality of entity-centric objects associated with the user to the requesting site for generating the presentation at the requesting site. Thus, for instance, the presentation may be generated at any number of different sites that are operable to cooperate in this manner with the source.

Various features may be further implemented for the above-described entity-centric objects. For instance, according to certain embodiments, the entity-centric objects are capable of receiving user input to enable a user to record notes that are to remain associated with the entity-centric object possessed by such user. As another example, a chat feature may be provided that enables users possessing a given entity-centric object to chat with each other.

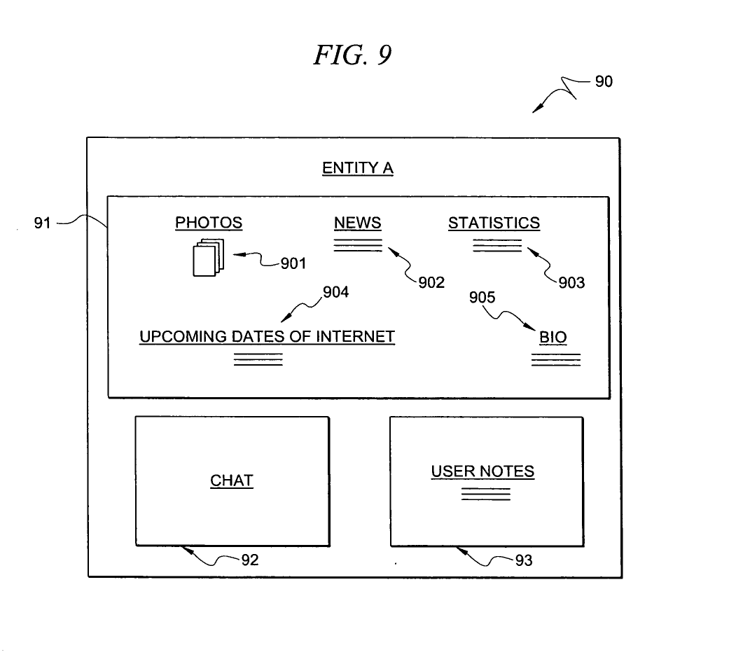

An example of a generated graphical presentation 90 of an entity-centric object (e.g., a generated ZoomCard) according to one embodiment is shown in FIG. 9. The graphical presentation 90 is an exemplary ZoomCard for an entity, shown as “Entity A.” Graphical presentation 90 includes a first portion 91 that presents various global information that is maintained (e.g., in database 24) for the entity-centric object. Various informational categories, such as photographs 901, news 902, statistics 903, upcoming dates of information 904, and biographical information 905, are presented, which each may include corresponding dynamically updated information. The global information of portion 91 may be maintained in the source database and supplied to all users possessing the Entity A ZoomCard. Thus, for instance, all users possessing Entity A's ZoomCard may be presented the global information 91 on their respective ZoomCards.

The exemplary graphical presentation 90 further includes a user-input section 93 to which a user possessing the Entity A entity-centric object can input information (e.g., make notes, etc.). In certain embodiments, the user-input information 93 is maintained private to a given user's respective ZoomCard. Thus, for instance, each user possessing a ZoomCard for Entity A may have their own user-input notes. Of course, in certain embodiments, users may be permitted to make their respective notes publicly visible to other users possessing a ZoomCard for Entity A.

Further, the exemplary graphical presentation 90 includes a user communication feature 92, shown as a “chat” feature, that enables a user to communicate with other users possessing the Entity A ZoomCard. According to one embodiment, a user may elect to be “chattable” for one or more entities by, for example, inputting information to the user interface (e.g., checking a check-box on a given ZoomCard). Such indication is communicated to ZoomCard server 23, and is made available to other users possessing the corresponding ZoomCard(s). The user may elect to send a “chat” message to all users possessing the corresponding card by, for example, inputting text to a text box provided with the ZoomCard interface (e.g., a text box on the card, a separate text window, etc.), wherein the input message is communicated to the ZoomCard server 23 and communicated therefrom to the other users possessing the ZoomCard who have selected to be “chattable” on the card. Similarly, the user may receive text messages from other users in a similar manner. Such chatting features are well-known in the art, and various associated features, such as enabling private chatting with selected user's possessing a given card (rather than global chat with all users possessing the card who are designated as chattable), etc., may likewise be available via the user interface.

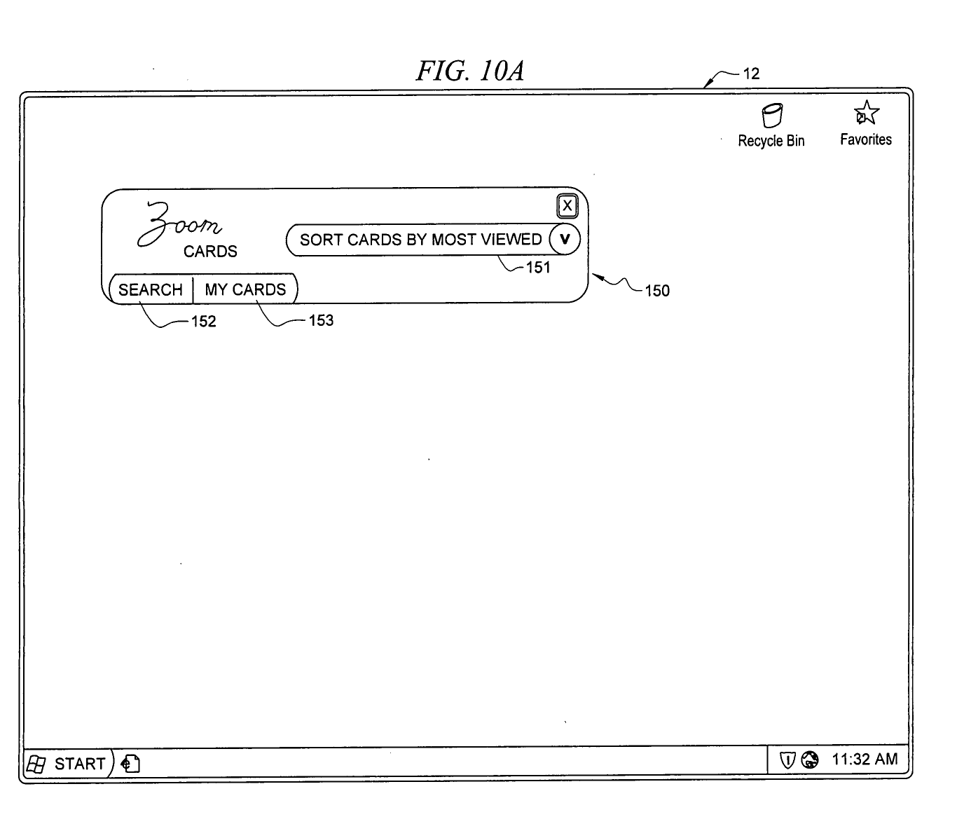

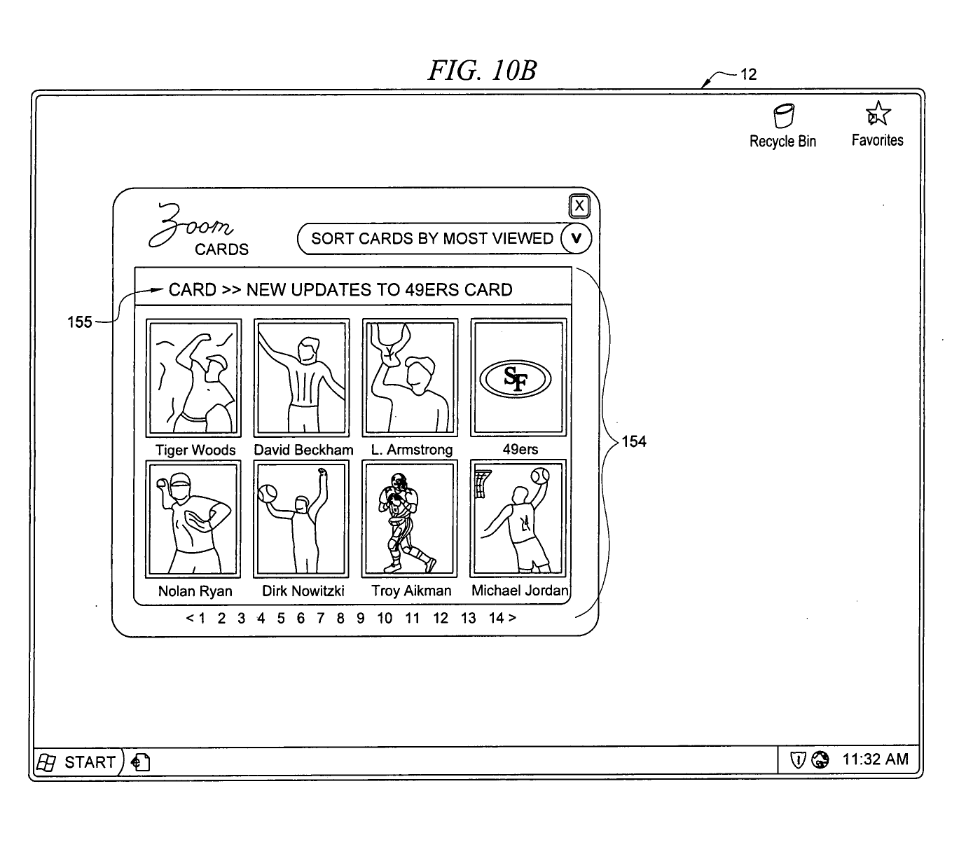

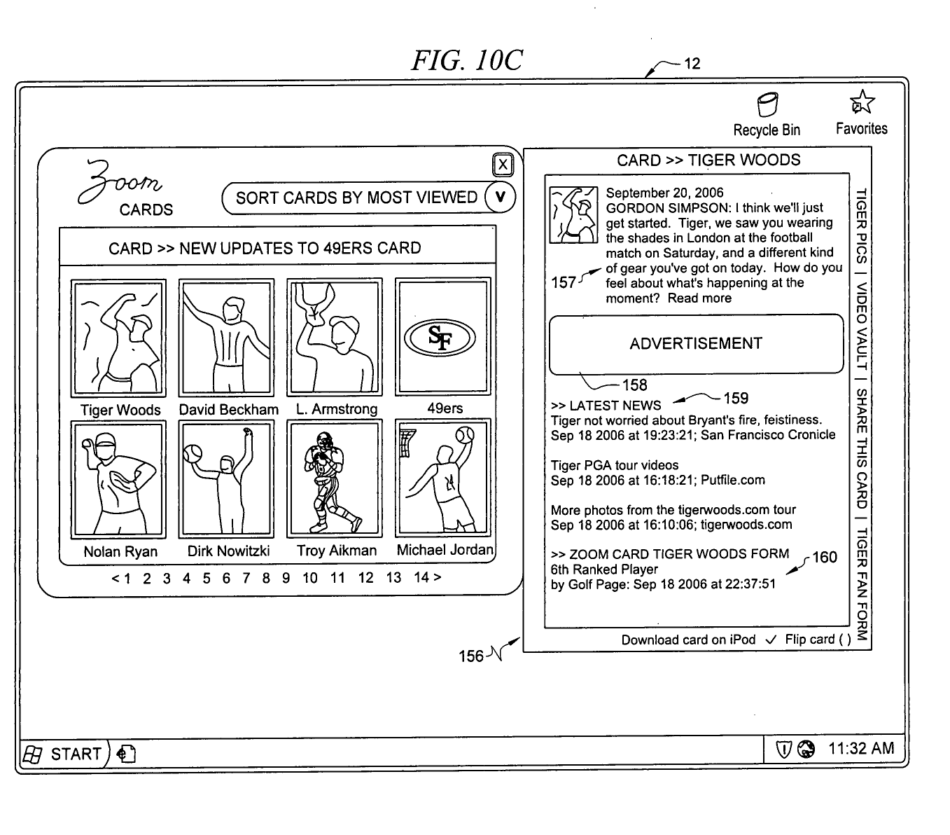

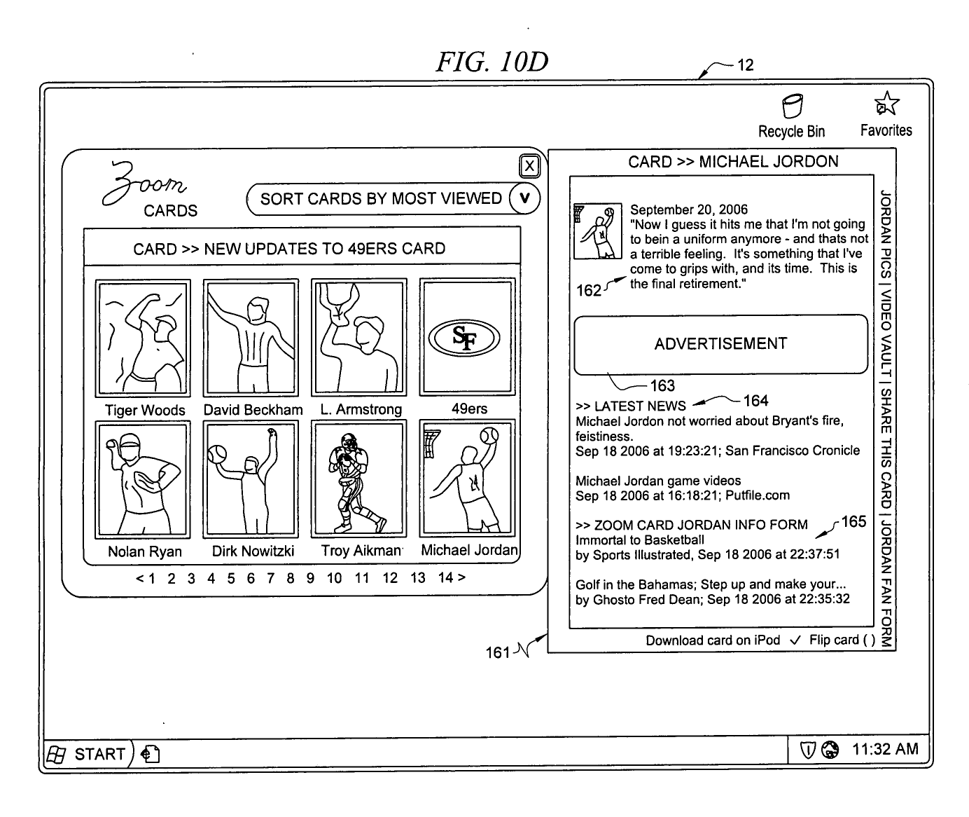

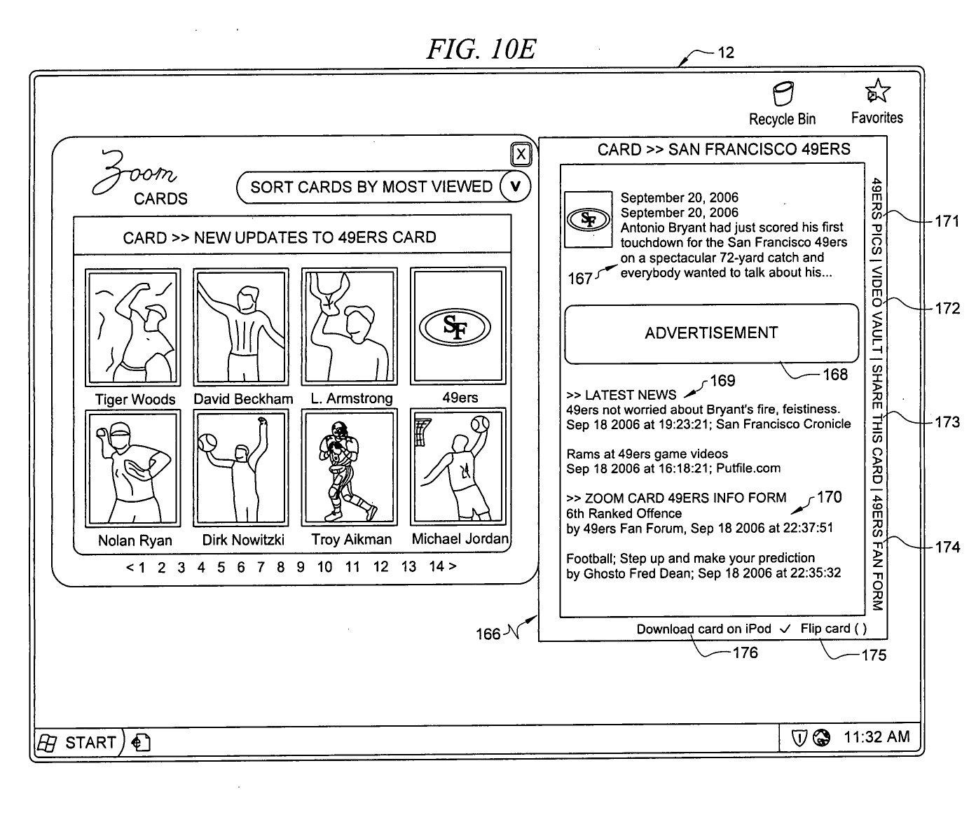

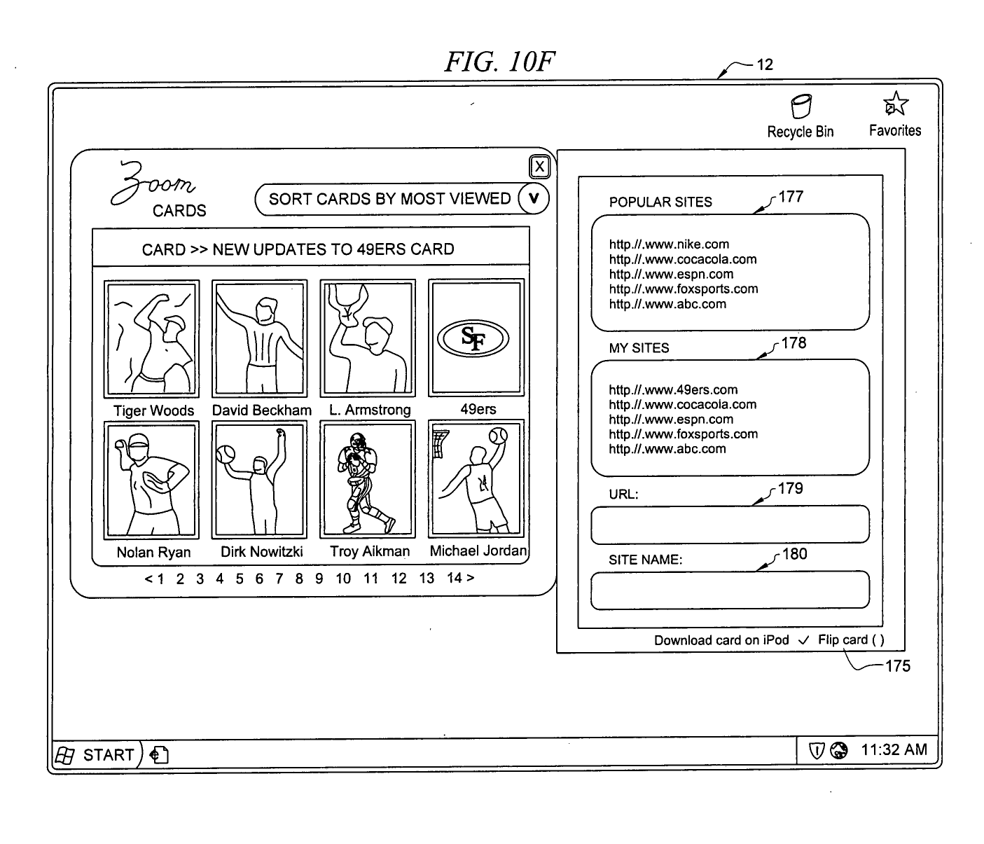

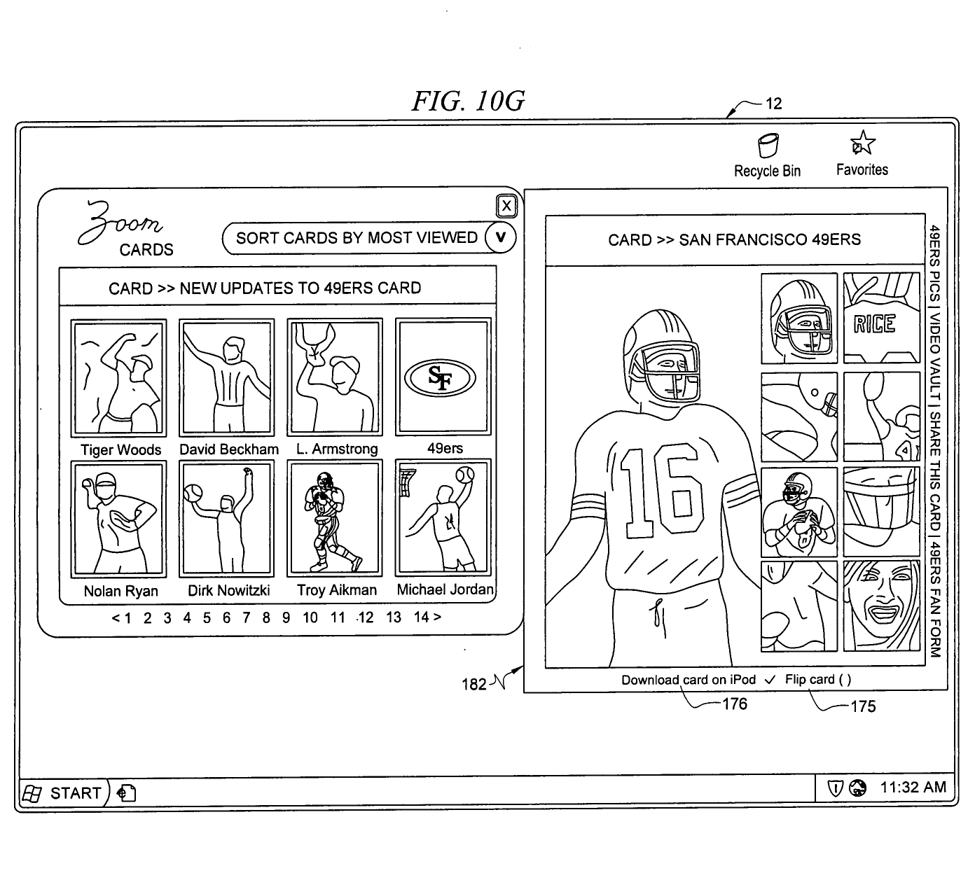

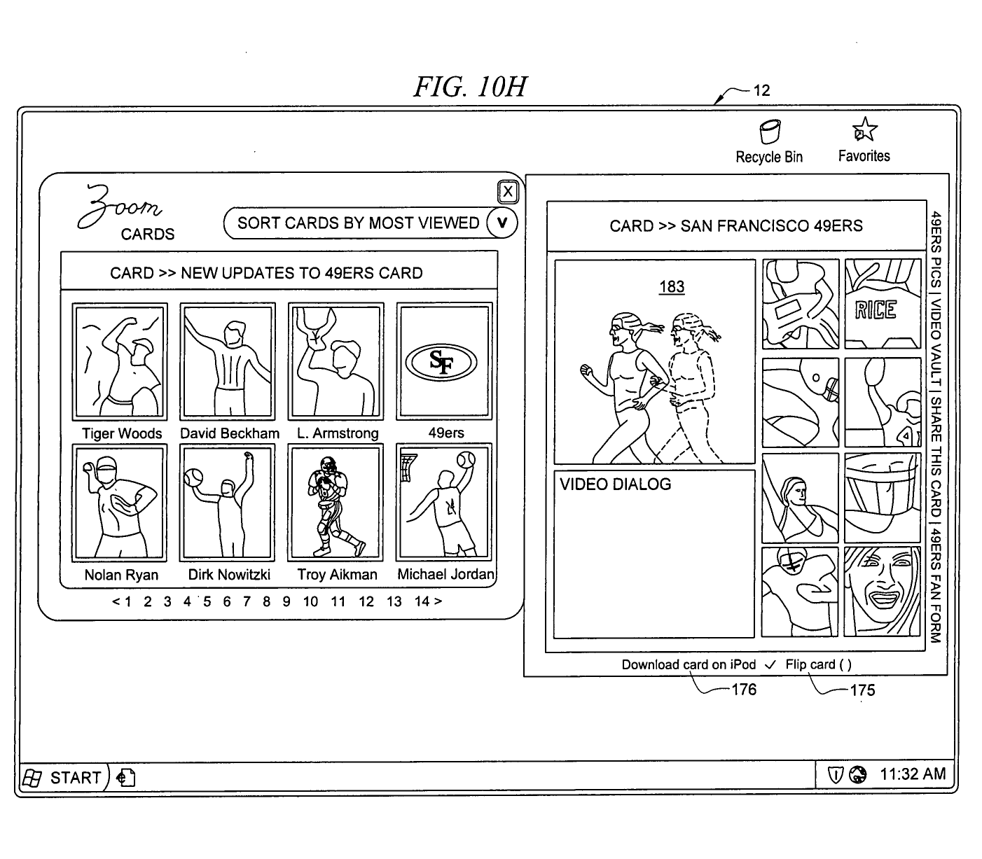

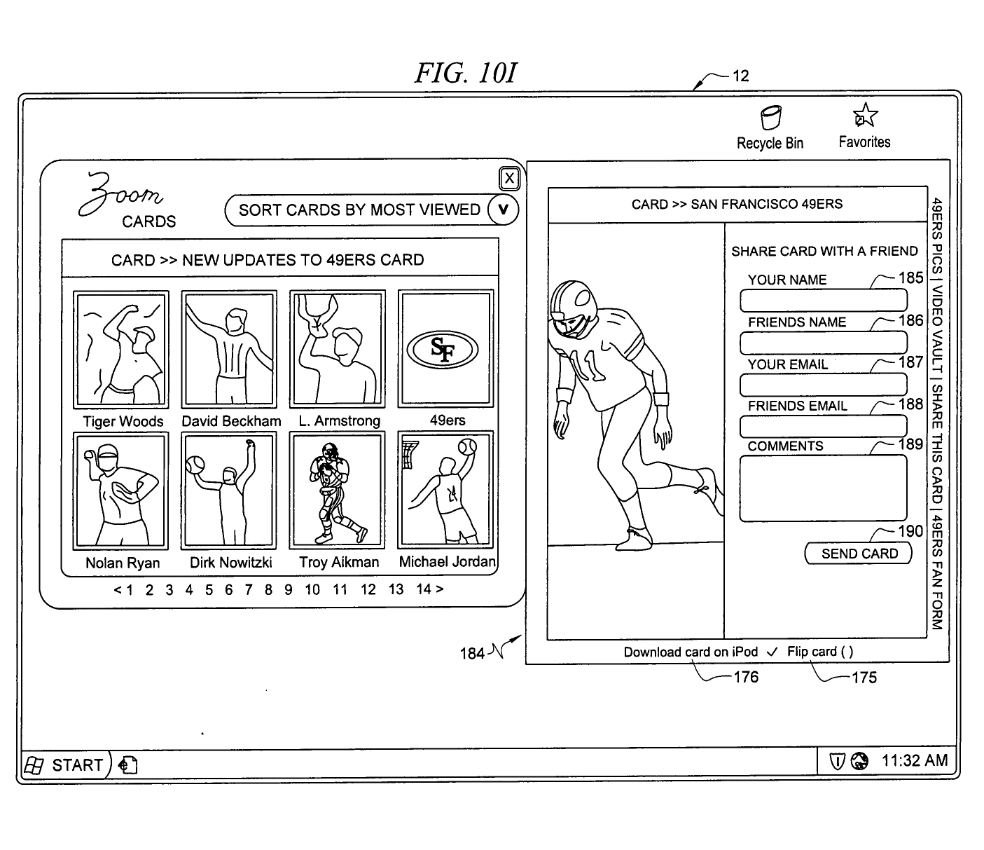

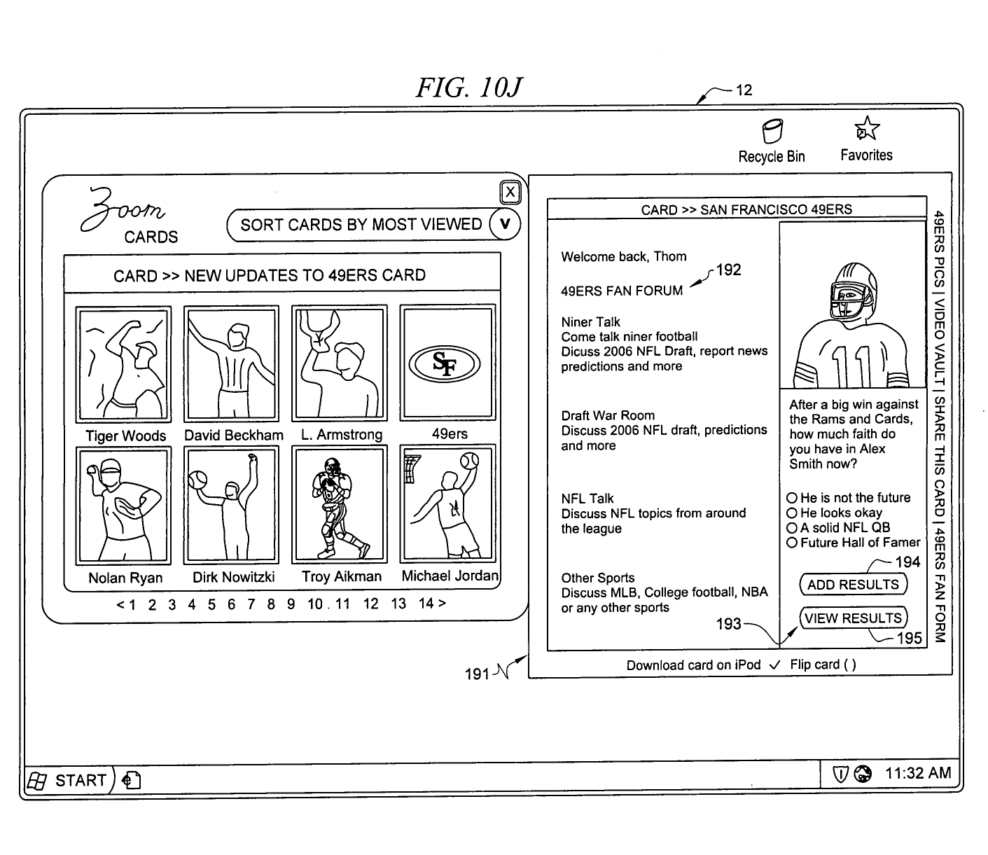

An exemplary user interface according to one embodiment of the present invention is now described in conjunction with FIGS. 10A-10J. FIG. 10A shows an exemplary control interface 150 that may be presented (e.g., by ZoomCard application 201) on a display 12 of a processor-based device, such as PC 11 of FIG. 1, according to one embodiment. Control interface 150 includes a sorting function 151 which may enable a user to sort the ZoomCards that the user possesses (e.g., by most viewed, etc.) and/or which may enable a user to organize ZoomCards into different collections (e.g., different decks), as discussed above. A button 152 is provided that enables a user to search for ZoomCards that are available for a given entity that is of interest to the user. For instance, responsive to activating (e.g., clicking on) search button 152, a text box may be displayed for receiving text from a user identifying a given entity of interest, which may be communicated to ZoomCard server 23 to determine whether a ZoomCard is available for such entity. A button 153 is also available, which when activated displays the user's ZoomCards (or collections of ZoomCards).

FIG. 10B shows an exemplary interface 154 that may be presented responsive to a user activating the “My Cards” button 153 of FIG. 10A according to one embodiment of the present invention. Interface 154 may include a notice as to recent informational updates made to cards that are possessed by the user, such as notice 155. Further interface 154 may display an identification of the various cards possessed by the user, which in this example include cards for Tiger Woods, David Beckham, Lance Armstrong, the 49ers football team, Nolan Ryan, Dirk Nowitzki, Troy Aikman, and Michael Jordan. Various other cards that are possessed may be viewed by scrolling through the numbered pages indicated at as 1-16 at the bottom of interface 154 in this example.

FIG. 10C shows an exemplary interface 156 presenting a ZoomCard for Tiger Woods, which may be presented responsive to a user activating (e.g., clicking on) the Tiger Woods card shown in FIG. 10B according to one embodiment of the present invention. As shown, such interface 156 includes various predefined categories of information pertaining to Tiger Woods, such as an interview 157 and latest news 159. A portion 160 of the presented card may include information pertaining to Tiger Woods golf form (e.g., illustrating his golf swing, etc.). Additionally, an advertisement 158 (e.g., a sponsor of Tiger Woods, golf-related advertisement, or other advertisement) may be presented on interface 156, which may be a link to the advertiser's website, to a video, and/or to other information pertaining to the advertiser. Various other information, as described further herein, may be included on interface 156 pertaining to Tiger Woods.

As another example, FIG. 10D shows an exemplary interface 161 presenting a ZoomCard for Michael Jordan, which may be presented responsive to a user activating (e.g., clicking on) the Michael Jordan card shown in FIG. 10B according to one embodiment of the present invention. As shown, such interface 161 includes various predefined categories of information pertaining to Michael Jordan, such as an interview 162 and latest news 164. Additionally, an advertisement 163 (e.g., a sponsor of Michael Jordan, basketball-related advertisement, or other advertisement) may be presented on interface 161, which may be a link to the advertiser's website, to a video, and/or to other information pertaining to the advertiser. Various other information, such as information 165, as described further herein, may be included on interface 161 pertaining to Michael Jordan.

As still another example, FIG. 10E shows an exemplary interface 166 presenting a ZoomCard for the San Francisco 49ers football team, which may be presented responsive to a user activating (e.g., clicking on) the 49ers card shown in FIG. 10B according to one embodiment of the present invention. As shown, such interface 166 includes various predefined categories of information pertaining to the 49ers football team, such as breaking news 167 about a player of the team, and latest news 169. Additionally, an advertisement 168 may be presented on interface 166, which may be a link to the advertiser's website, to a video, and/or to other information pertaining to the advertiser. Various other information, such as information 170, as described further herein, may be included on interface 166 pertaining to the 49ers football team.

As the exemplary interface 166 of FIG. 10E further illustrates, an interface displaying a ZoomCard for a named-entity, such as the 49ers, may include various interactive functions, such as functions 171-176 described further herein. A “flip card” button 175 may be included, which enables a user to graphically flip the ZoomCard to view the “back” of the card, an example of which is shown in FIG. 1 OF. As FIG. 1 OF shows, various information may be stored on the “back” of the graphically represented card, including user-input information, as discussed above. In the specific example illustrated in FIG. 1 OF, the back of the card includes a listing 177 of popular sites relating to the 49ers, a listing 178 of the user-supplied sites, a text box 179 for receiving user input of a URL, and a text box 180 for receiving user input of a site name (for a URL input in box 179). Further, an “add link” button 181 is supplied, which when activated may add the URL and site name of boxes 179-180 to the listing 178 of user-supplied sites. A user can return to the “front” of the card (shown in FIG. 10E) by again activating the “flip card” button 175.

Tab 171 shown in FIG. 10E, when activated, enables a user to view pictures relating to the 49ers, such as in the exemplary interface 182 of FIG. 10G. Tab 172 shown in FIG. 10E, when activated, enables a user to view videos relating to the 49ers, such as in the exemplary interface of FIG. 10H, wherein a selected video 183 may be played in an appropriate media player, such as RealPlayer, Microsoft's MediaPlayer, etc.

Tab 173 shown in FIG. 10E, when activated, enables a user to share the ZoomCard with another person. That is, the user can send the ZoomCard to another person so that the recipient can possess the card in his/her ZoomCard deck(s) of cards. As an example, responsive to activating tab 173, an interface 184 shown in FIG. 10I may be presented, which includes text boxes 185-189 for receiving user input specifying the sender's name, the recipient's name, the sender's email address, the recipient's email address, and comments from the sender, respectively. A send card button 190 is included, which when activated sends the entity-centric object corresponding to this entity to the email address specified in text box 188, along with the comment 189 included in the body of the email, for example.

Tab 174 shown in FIG. 10E, when activated, enables a user to view a “fan vault”, such as the exemplary interface 191 shown in FIG. 10J. As shown in FIG. 10J, the fan vault interface 191 may enable discussion forums 192 with other holders of this ZoomCard and/or identify generally available discussion forums (e.g., among persons including those who do not possess the ZoomCard) relating to this entity (e.g., the 49ers in this example). Further features may also be available, such as a polling feature 193 that enables holders of a given card to participate in a poll by answering questions and submitting their answers (via button 194) and/or view the results of the poll (via button 195).

A further exemplary functionality that may be supported by the exemplary interface 166 of FIG. 10E includes a download capability 176, which when activated may enable a user to download the ZoomCard (or portions thereof, such as videos, pictures, etc.) to another device, such as a portable computing device (e.g., an iPod™, etc.).

Many of the elements described herein, when implemented via computer-executable instructions, are in essence the software code defining the operations thereof. For instance, the above-described entity-centric objects, as well as database management operations (e.g., for performing database lookups, etc.), at least some of the data maintenance operations (e.g., of maintainer 204), logic for generating a presentation of entity-centric objects on a user's computing device (e.g., via ZoomCard application 201), comprise software code for performing such operations. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information. In certain embodiments, a CPU may execute the various logical instructions according to embodiments of the present invention. For example, a CPU may execute machine-level instructions according to the exemplary operational flows described above in conjunction with FIGS. 7-8.

It shall be appreciated that the present invention is not limited to the architecture of the system on embodiments thereof may be implemented. For example, any suitable processor-based device may be utilized for implementing the above-described operations, including without limitation personal computers, laptop computers, computer workstations, and multi-processor servers. Moreover, certain aspects of embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
maintaining a plurality of entity-centric objects that each contain dynamically updated information about a respective entity;
receiving, from a user, selection of at least one entity that is of interest to the user;
associating with the user at least one of said entity-centric objects corresponding to said selected at least one entity; and
generating a presentation to said user of said dynamically updated information contained in said at least one of said entity-centric objects associated with the user, wherein said generating said presentation is site-independent.

2. The method of claim 1 wherein said maintaining comprises:
periodically searching a plurality of different information sources for information pertaining to said respective entity;
filtering said information pertaining to said respective entity for new information not already contained in the entity-centric object; and
updating the entity-centric object to store the new information.

3. The method claim 1 wherein said maintaining comprises:
storing said dynamically updated information for said plurality of entity-centric objects on at least one server that is communicatively coupled to a communication network.

4. The method of claim 3 wherein said receiving comprises:
receiving at said at least one server said selection from said user via said communication network.

5. The method of claim 3 wherein said associating comprises:
storing data at the at least one server that associates said user with said at least one of said entity-centric objects corresponding to said selected at least one entity.

6. The method of claim 1 wherein said maintaining comprises:
defining categories of said dynamically updated information that is contained in said plurality of entity-centric objects.

7. The method of claim 6 wherein the categories of information include at least one of: news, biographical information, statistical information, dates of interest, pictures, and videos.

8. The method of claim 6 wherein said maintaining comprises:
organizing said dynamically updated information about an entity into a corresponding category of a respective entity-centric object.

9. The method of claim 1 wherein said generating a presentation to said user comprises:
generating a presentation of said dynamically updated information contained in said at least one of said entity-centric objects associated with the user as an electronic card for each of said at least one of said entity-centric objects.

10. The method of claim 1 further comprising:
responsive to a user requesting content from a content server, said content server communicatively accessing a central server, and said content server determining, from information received from the central server, said at least one of said entity-centric objects associated with the user.

11. The method of claim 10 further comprising:
said content server modifying its content for communication to the user to include said presentation of said dynamically updated information contained in said at least one of said entity-centric objects associated with the user.

12. The method of claim 1 further comprising:
receiving at a user's computer content from a content server, wherein an application executing on the user's computer modifies the content received from the content server to include said presentation to said user of said dynamically updated information contained in said at least one of said entity-centric objects associated with the user.

13. The method of claim 1 further comprising:
receiving at a user's computer content from a content server, wherein an application executing on the user's computer examines the content received from the content server to identify a reference in the content to an entity for which a respective entity-centric object is associated with the user, wherein the application modifies the content to include said presentation to said user of said dynamically updated information contained in the respective entity-centric object for an identified entity.

14. The method of claim 1 wherein the at least one entity comprises a named-entity.

15. The method of claim 14 wherein the named-entity comprises one selected from the group consisting of: an identifiable live being, an identifiable group of live beings, and an identifiable event.

16. The method of claim 15 wherein said identifiable live being comprises one selected from the group consisting of: an athlete, a celebrity, an actor, an actress, a participant on a reality television program, an author, a musician, and an identifiable animal.

17. The method of claim 15 wherein said identifiable group of live beings comprises one selected from the group consisting of: a sporting organization, a sports team, a musical group, members of a particular family, and members of a particular entertainment program.

18. The method of claim 15 wherein said identifiable event comprises one selected from the group consisting of: any periodically repeating event in which live beings participate, a sporting event, an awards event, and a musical concert.

19. The method of claim 1 further comprising:
enabling said user to define collections of different entity-centric objects associated with the user.

20. The method of claim 1 further comprising:
said generated presentation enabling communication with other users associated with said at least one of said entity-centric objects with which said user is associated.

21. The method of claim 20 wherein said generating said presentation comprises:
generating an interface for text chatting with others.

22. The method of claim 1 further comprising:
said generated presentation enabling user-input to said at least one of said entity-centric objects with which said user is associated.

23. The method of claim 22 wherein said generating said presentation comprises:
generating an interface for receiving user input of information to be stored for the at least one entity-centric object associated with the user.

24. A method comprising:
maintaining, on at least one server communicatively coupled to a communication network, a plurality of entity-centric objects that each contain dynamically updated information about a respective named-entity;
receiving, from a client computer device communicatively coupled to said communication network, selection of at least one named-entity that is of interest to a user;
associating, on the at least one server, the user with ones of said plurality of entity-centric objects that correspond to said selected at least one named-entity; and
generating a presentation on said client computing device of said dynamically updated information contained in said ones of said plurality of entity-centric objects associated with the user, wherein said generating said presentation is site-independent.

25. The method of claim 24 wherein said maintaining comprises:
periodically searching a plurality of different information sources for information pertaining to said respective named-entity;
filtering said information pertaining to said respective named-entity for new information not already contained in the entity-centric object; and
updating the entity-centric object to store the new information.

26. The method of claim 24 wherein said associating comprises:
storing data on the at least one server that associates said user with said at least one of said entity-centric objects corresponding to said selected at least one named-entity.

27. The method of claim 24 wherein said generating a presentation on said client computing device comprises:
generating a presentation of said dynamically updated information contained in said at least one of said entity-centric objects associated with the user as an electronic card for each of said at least one of said entity-centric objects.

28. The method of claim 24 further comprising:
responsive to a user requesting content from a content server, said content server communicatively accessing said at least one server, and said content server determining, from information received from the at least one server, said at least one of said entity-centric objects associated with the user.

29. The method of claim 28 further comprising:
said content server modifying its content for communication to the client computing device to include said presentation of said dynamically updated information contained in said at least one of said entity-centric objects associated with the user.

30. The method of claim 24 further comprising:
receiving at said client computing device content from a content server, wherein an application executing on the client computing device modifies the content received from the content server to include said presentation to said user of said dynamically updated information contained in said at least one of said entity-centric objects associated with the user.

31. The method of claim 24 further comprising:
receiving at said client computing device content from a content server, wherein an application executing on the client computing device examines the content received from the content server to identify a reference in the content to a named-entity for which a respective entity-centric object is associated with the user, wherein the application modifies the content to include said presentation to said user of said dynamically updated information contained in the respective entity-centric object for an identified named-entity.

32. The method of claim 24 wherein the named-entity comprises one selected from the group consisting of: an identifiable live being, an identifiable group of live beings, and an identifiable event.

33. A system comprising:
at least one server communicatively coupled to a communication network, wherein said at least one server is communicatively coupled to at least one data storage device to which a plurality of entity-centric objects containing dynamically updated information about a respective named-entity are stored;
said at least one server further communicatively coupled to at least one data storage device to which a relationship between users and ones of said plurality of entity-centric objects possessed by said users is defined; and
said at least one server operable to send the dynamically updated information of the ones of entity-centric objects possessed by a given user for presentation of said dynamically updated information on a client computing device, wherein the presentation is available via any of a plurality of different sites.

34. The system of claim 33 wherein said at least one server is operable to:
periodically search a plurality of different information sources for information pertaining to said respective named-entity;
filtering said information pertaining to said respective named-entity for new information not already contained in the entity-centric object; and
updating the entity-centric object to store the new information.

35. The system of claim 33 further comprising:
said client computing device operable to present a generated user interface containing said dynamically updated information contained in said at least one of said entity-centric objects associated with the user as an electronic card for each of said at least one of said entity-centric objects.

36. The system of claim 33 further comprising:
a content server that, responsive to a user requesting content from said content server, is operable to communicatively access said at least one server and determine from information received from the at least one server said at least one of said entity-centric objects associated with the user.

37. The system of claim 36 further comprising:
said content server operable to modify its content for communication to the client computing device to include said presentation of said dynamically updated information contained in said at least one of said entity-centric objects associated with the user.

38. The system of claim 33 further comprising:
said client computing device operable to receive content from a content server, wherein an application executing on the client computing device modifies the content received from the content server to include said presentation to said user of said dynamically updated information contained in said at least one of said entity-centric objects associated with the user.

39. The system of claim 33 further comprising:
said client computing device operable to receive content from a content server, wherein an application executing on the client computing device examines the content received from the content server to identify a reference in the content to a named-entity for which a respective entity-centric object is associated with the user, wherein the application modifies the content to include said presentation to said user of said dynamically updated information contained in the respective entity-centric object for an identified named-entity.

40. The system of claim 33 wherein the named-entity comprises one selected from the group consisting of: an identifiable live being, an identifiable group of live beings, and an identifiable event.
